(19) United States
(12) Patent Application Publication
(10) Pub. No.: US 2012/0196075 A1
(43) Pub. Date: Aug. 2, 2012

(54) RESIN COMPOSITION, SEMICONDUCTOR WAFER BONDING PRODUCT AND SEMICONDUCTOR DEVICE

(76) Inventors: Toyosei Takahashi, Shinagawa-ku (JP); Masakazu Kawata, Shinagawa-ku (JP); Masahiro Yoneyama, Shinagawa-ku (JP); Hirohisa Dejima, Shinagawa-ku (JP); Fumihiro Shiraishi, Shinagawa-ku (JP); Toshihiro Sato, Shinagawa-ku (JP)

(21) Appl. No.: 13/502,002

(22) PCT Filed: Oct. 14, 2010
(86) PCT No.: PCT/JP2010/068078

§ 371 Date: Apr. 13, 2012

(30) Foreign Application Priority Data
Oct. 15, 2009 (JP) 2009-238757
Oct. 15, 2009 (JP) 2009-239756

(51) Int. Cl. B32B 3/02; C09J 163/00

(52) U.S. Cl. 428/64.1; 522/111

(57) ABSTRACT

A resin composition of the present invention is used for providing a spacer 104 having a grid-like shape at a planar view thereof between a semiconductor wafer 101′ and a transparent substrate 102. The resin composition includes a constituent material containing an alkali soluble resin, a thermosetting resin and a photo initiator. In the case where a semiconductor wafer 101′ and a transparent substrate 102 are bonded together through a spacer 104 formed on a substantially overall surface thereof to obtain a bonded body 2000, and then the semiconductor wafer makes one-fifth thickness, a warpage of the bonded body 2000 is 3,000 μm or less. Further, it is preferred that the warpage of the bonded body 2000 before the process thereof is 500 μm or less, and an increasing ratio of the warpage of the bonded body 2000 after the process thereof is 600% or less.

### TECHNICAL FIELD

The present invention relates to a resin composition, a semiconductor wafer bonding product and a semiconductor device.

### RELATED ART

Semiconductor devices represented by a CMOS image sensor, a CCD image sensor and the like are known. In general, such a semiconductor device includes a semiconductor substrate provided with a light receiving portion, a spacer provided on the semiconductor substrate, and a transparent substrate bonded to the semiconductor substrate via the spacer.

In order to improve productivity of such a semiconductor device, a method in which the semiconductor device is manufactured using a photosensitivity film is conceived (for example, Patent document: JP-A 2008-91399).

For example, a plurality of semiconductor devices are manufactured at the same time using such a photosensitivity film as follows.

First, the photosensitivity film (spacer formation film) is attached onto a semiconductor wafer provided with light receiving portions so as to cover the light receiving portions of the semiconductor wafer.

Next, the photosensitivity film is selectively irradiated with light (exposed), and then developed. In this way, a grid-like spacer (spacer substrate) is formed by selectively leaving the photosensitivity film on an area of the semiconductor wafer surrounding each light receiving portion.

Next, the semiconductor wafer on which the spacer is formed faces a transparent substrate (transparent wafer) through the spacer, and then is bonded to the transparent substrate, to thereby obtain a semiconductor wafer bonding product in which the semiconductor substrate and the transparent substrate are bonded together through the spacer.

Next, by dicing the semiconductor wafer bonding product so as to correspond to each light receiving portion provided on the semiconductor wafer, a plurality of semiconductor devices are manufactured at the same time.

As described above, the semiconductor device is manufactured by dicing the semiconductor wafer bonding product in which the semiconductor wafer and the transparent substrate are bonded together through the spacer. On the other hand, recently, it is required that a thickness of the semiconductor wafer is in the range of about 100 to 600 μm for downsizing or sliming the semiconductor device, and that the thickness of the semiconductor wafer is about 50 μm for further downsizing or making the semiconductor device thinner.

Further, in order to set the thickness of the semiconductor wafer to such a small value, the semiconductor wafer is passed through a back grinding step in which a surface thereof opposite to the spacer is ground and/or polished. Practically, after this back grinding step, the semiconductor wafer tends to warp or warpage of the semiconductor wafer is likely to be increased.

Such a semiconductor wafer bonding product, in which the warp occurs, is subjected to a back side process (e.g. TSV process), a dicing process and the like after the back grinding step.

The back side process includes, for example, a step of laminating a photosensitive resist onto the semiconductor wafer bonding product, a step of exposing the photosensitive resist and a step of developing the photosensitive resist, and these steps are successively carried out.

Therefore, in the case where the semiconductor wafer bonding product is set to machines such as a laminator, an exposure machine (stepper), a developing machine and a dicing saw, the semiconductor wafer bonding product is received into a magazine case, and then the magazine case is set to the machines. At this time, if the warpage of the semiconductor wafer bonding product has become large after the back grinding step, the semiconductor wafer bonding product cannot be received into the magazine case and cannot be properly set to the machines. This causes a fault that the semiconductor wafer bonding product cannot be passed through the above steps of the back side process.

Further, each machine transfers the semiconductor wafer bonding product or secures the semiconductor wafer bonding product onto a stage by sucking it. Therefore, even if the semiconductor wafer bonding product can be received into the magazine case, in the case where the warpage of the semiconductor wafer bonding product has become large after the back grinding step, the semiconductor wafer bonding product cannot be properly transferred or secured by the sucking operation. This also causes a fault that the semiconductor wafer bonding product cannot be subjected to the back side process and the dicing process.

### SUMMARY OF THE INVENTION

It is an object of the present invention to provide a resin composition which can obtain a spacer capable of reducing a warpage of a semiconductor wafer bonding product manufactured by bonding a semiconductor wafer and a transparent substrate together through the spacer, the semiconductor wafer bonding product in which a back side of the semiconductor wafer is ground and/or polished, and to provide a semiconductor wafer bonding product in which a warpage thereof is reduced.

In order to achieve such an object, the present invention includes the following features (1) to (12).

(1) A resin composition adapted to be used for providing a spacer having a grid-like shape at a planar view thereof between a semiconductor wafer and a transparent substrate, the resin composition comprising:

a constituent material containing an alkali soluble resin, a thermosetting resin and a photo initiator,

wherein in the case where a semiconductor wafer having a substantially circular shape, a diameter of 8 inches and a thickness of 725 μm and a transparent substrate having a substantially circular shape, a diameter of 8 inches and a thickness of 350 μm are bonded together through a spacer formed on a substantially overall surface of the semiconductor wafer or the transparent substrate using the resin composition to thereby obtain a bonded body, a surface of the semiconductor wafer opposite to the spacer is subjected to a process for substantially uniformly grinding and/or polishing it so that the semiconductor wafer has one-fifth thickness, and then the bonded body is placed on a flat surface so that the transparent substrate is located on the downside facing to the flat surface, a maximal height of a space to be defined between the flat surface and the transparent substrate, which corresponds to a warpage of the bonded body, is 3,000 μm or less.

(2) The resin composition according to the feature (1), wherein the warpage of the bonded body before the grinding and/or polishing process is 500 μm or less, and an increasing ratio of the warpage of the bonded body after the process thereof is 600% or less.

(3) The resin composition according to the feature (1), wherein the alkali soluble resin is a (meth)acryl-modified phenol resin.

(4) The resin composition according to the feature (1), wherein the thermosetting resin is an epoxy resin.

(5) The resin composition according to the feature (1), wherein the constituent material further contains a photo polymerizable resin.

(6) The resin composition according to the feature (1), wherein the spacer is obtained by photo curing and thermal curing a layer formed of the resin composition.

(7) The resin composition according to the feature (1), wherein an elastic modulus at 25° C. of the spacer is in the range of 0.1 to 15 GPa.

(8) The resin composition according to the feature (1), wherein a linear expansion coefficient at to 30° C. of the spacer is in the range of 3 to 150 ppm/° C.

(9) The resin composition according to the feature (1), wherein a residual stress at 25° C. of the spacer is in the range of 0.1 to 150 MPa.

(10) The resin composition according to the feature (1), wherein a thickness of the spacer is in the range of 5 to 500 μm.

(11) A semiconductor wafer bonding product having a substantially circular shape, in which a semiconductor wafer, a spacer formed of the resin composition according to the feature (1) so as to have a plurality of air-gap portions provided in a grid pattern and a transparent substrate are laminated in this order.

(12) A semiconductor device obtained by dicing the semiconductor wafer bonding product according to the feature (11).

### BRIEF DESCRIPTION OF THE DRAWINGS

FIG. 1 is a sectional view showing one example of a semiconductor device.

FIG. 2 is a flow chart showing one example of a method of manufacturing the semiconductor device.

FIG. 3 is a flow chart showing the one example of the method of manufacturing the semiconductor device, which is continued from FIG. 2.

FIG. 4 is a top view showing a semiconductor wafer bonding product of the present invention to be obtained in the course of manufacturing the semiconductor device.

FIG. 5 is a longitudinal sectional view showing a warpage of a bonded body.

### MODE FOR CARRYING OUT THE INVENTION

Hereinafter, description will be made on a resin composition and a semiconductor wafer bonding product of the present invention based on a preferred embodiment shown in the accompanying drawings.

<Semiconductor Device (Image Sensor)>

First, description will be made on a semiconductor device (semiconductor element) manufactured using the semiconductor wafer bonding product of the present invention, prior to the description of the resin composition and the semiconductor wafer bonding product of the present invention.

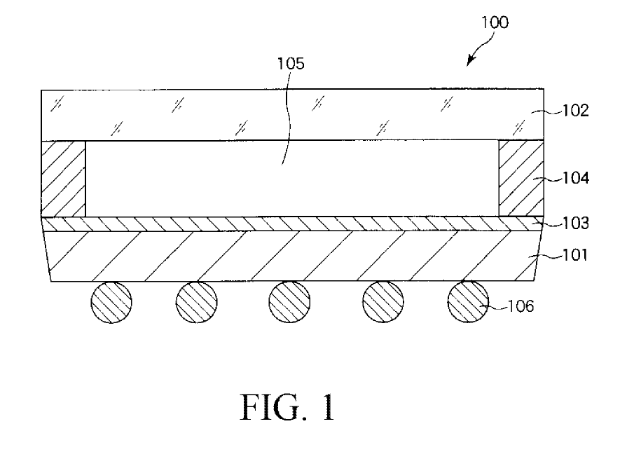

FIG. 1 is a longitudinal sectional view showing one example of the semiconductor device manufactured using the semiconductor wafer bonding product of the present invention. In this regard, in the following description, the upper side in FIG. 1 will be referred to as “upper” and the lower side thereof will be referred to as “lower”.

As shown in FIG. 1, a semiconductor device (light receiving device) 100 includes a base substrate 101, a transparent substrate 102 provided so as to face the base substrate 101, an individual circuit 103 formed on the base substrate 101 and having a light receiving portion, a spacer 104 provided along an edge portion of the individual circuit 103 having the light receiving portion, and solder bumps 106 each formed on a lower surface of the base substrate 101.

The base substrate 101 is a semiconductor substrate on which a circuit not shown in FIG. 1 (that is, an individual circuit provided on a semiconductor wafer described below) is provided.

On the base substrate 101, the individual circuit 103 having the light receiving portion is provided. For example, the individual circuit 103 having the light receiving portion has a structure in which a light receiving element and a microlens array are stacked on the base substrate 101 in this order.

The transparent substrate 102 is provided so as to face the base substrate 101 and has a planar size substantially equal to a planar size of the base substrate 101. Examples of the transparent substrate 102 include an acryl resin substrate, a polyethylene terephthalate resin (PET) substrate, a glass substrate and the like.

The spacer 104 is directly bonded to both the microlens array of the individual circuit 103 having the light receiving portion and the transparent substrate 102 along edge portions thereof. In this way, the base substrate 101 and the transparent substrate 102 are bonded together through the spacer 104. Further, the spacer 104 forms (defines) an air-gap portion 105 between the individual circuit 103 having the light receiving portion (microlens array) and the transparent substrate 102.

This spacer 104 is provided along the edge portion of the individual circuit 103 having the light receiving portion so as to surround a central area thereof. Therefore, an area of the individual circuit 103 having the light receiving portion surrounded by the spacer 104 can substantially function as a light receiving portion.

In this regard, it is to be noted that examples of the light receiving element of the individual circuit 103 having the light receiving portion include CCD (Charge Coupled Device), a CMOS (Complementary Metal Oxide Semiconductor) image sensor and the like. In the light receiving element, light received by the individual circuit 103 having the light receiving portion is changed to electrical signals.

The solder bumps 106 have conductivity and are electrically connected to a circuit provided on the base substrate 101 at the lower surface and an inside thereof. This makes it possible for the electrical signals changed from the light by the individual circuit 103 having the light receiving portion to be transmitted to the solder bumps 106.

For example, such a semiconductor device 100 can be manufactured as follows.

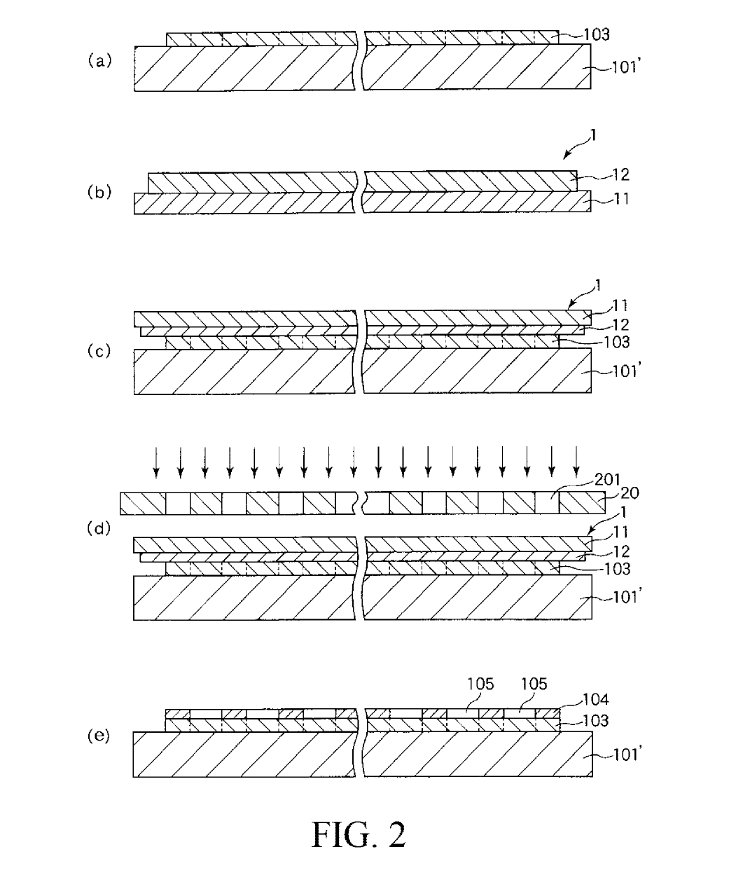

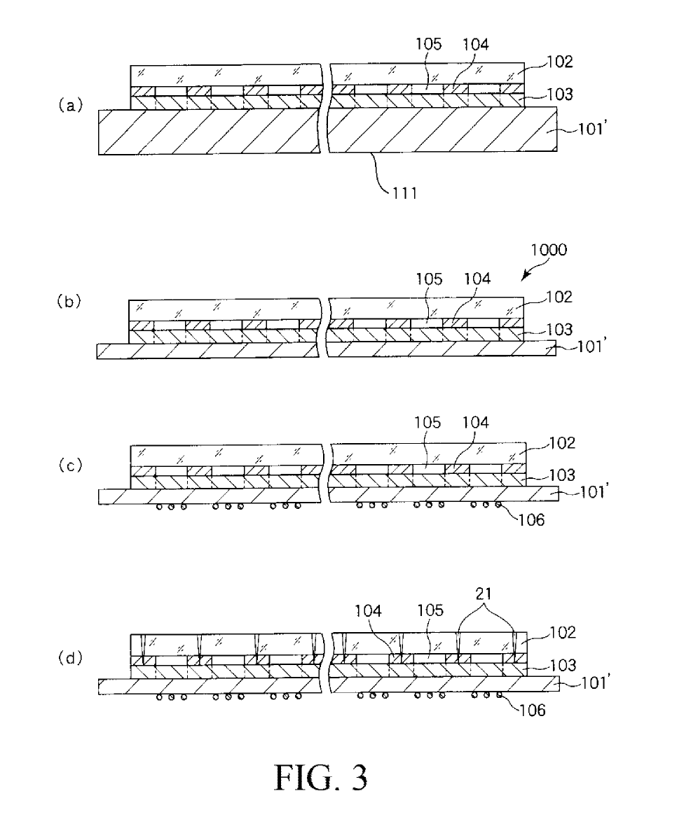

FIGS. 2 and 3 are longitudinal sectional views each showing a method of manufacturing the semiconductor device. In this regard, in the following description, the upper side in each of FIGS. 2 and 3 will be referred to as “upper” and the lower side thereof will be referred to as “lower”.

[1] First, prepared is a semiconductor wafer 101′ on which the individual circuits 103 having the light receiving portions are provided and a plurality of individual circuits (not shown) each corresponding to one semiconductor device 100 are formed.

In this embodiment, as shown in FIG. 2(a), the individual circuit 103 having the light receiving portion is integrally formed with the individual circuit provided on the semiconductor wafer 101′.

[2] Next, on a side of an upper surface of the semiconductor wafer 101′, that is, on a side of the semiconductor wafer 101′ where the individual circuits 103 having the light receiving portions are provided, a spacer formation layer 12 having a bonding property is formed.

Examples of a method of forming this spacer formation layer 12 include, but not are limited to, I: a method in which the spacer formation layer 12 formed on a support base (film) 11 is transferred on the semiconductor wafer 101′, II: a method in which a varnish (liquid material) containing a constituent material of the spacer formation layer 12 is coated onto the semiconductor wafer 101′, and then dried to obtain the spacer formation layer 12, III: a method in which the varnish containing the constituent material of the spacer formation layer 12 is directly drawn onto the semiconductor wafer 101′, and the like.

Among these methods, it is preferable to use the method “I”. In the method “I”, by exposing the spacer formation layer 12 through the support base 11, it is possible to effectively prevent dust or the like from involuntarily adhering to the spacer formation layer 12.

Hereinbelow, description will be made on a case that the spacer formation layer 12 is formed onto the semiconductor wafer 101′ using the method “I” as an example.

[2-1] First, as shown in FIG. 2(b), prepared is a spacer formation film 1 in which the spacer formation layer 12 is provided on the support base 11.

In the present invention, the spacer formation layer 12 contains an alkali soluble resin, a thermosetting resin and a photo initiator. Such a spacer formation layer 12 has three properties including a photo curable property that a region irradiated with light is cured, an alkali developing property that a region not irradiated with the light is dissolved by an alkali solution, and a thermal curable property that the region irradiated with the light is further cured by being heated.

Description will be made on a constituent material of a resin composition to be used for forming the spacer formation layer 12 in detail below.

The support base (film) 11 is a sheet-like base and has a function for supporting the spacer formation layer 12.

In the case where the spacer formation layer is irradiated with the light through the support base 11 as described below (that is, an exposure step [4] is carried out), this support base 11 is formed of a material having optical transparency. By exposing the spacer formation layer 12 through the support base 11 having such a structure, it is possible to reliably expose the spacer formation layer 12, while effectively preventing dust or the like from involuntarily adhering to the spacer formation layer 12 during the manufacture of the semiconductor device 100.

Examples of a constituent material of such a support base 11 include polyethylene terephthalate (PET), polypropylene (PP), polyethylene (PE) and the like. Among them, it is preferable to use the polyethylene terephthalate (PET) from the viewpoint that the support base 11 can exhibit both optical transparency and rupture strength in excellent balance.

In this regard, for example, such a spacer formation film 1 can be obtained by dissolving the alkali soluble resin, the thermosetting resin and the photo initiator, when necessary, other components such as a photo polymerizable resin into a solvent to prepare a material for forming the spacer formation layer (liquid material), and then applying the liquid material onto the support base 11 and drying the liquid material due to removal of the solvent thereof at a predetermined temperature.

Here, the solvent to be used is not limited to a specific kind. As the solvent, a solvent inert with respect to the constituent material of the spacer formation layer (resin composition) 12 is preferably used.

Specifically, examples of such a solvent include: ketones such as acetone, methyl ethyl ketone, methyl isobutyl ketone, DIBK (diisobutyl ketone), cyclohexanone and DAA (diacetone alcohol); esters such as ethyl acetate and butyl acetate; aromatic hydrocarbons such as benzene, xylene and toluene; alcohols such as methyl alcohol, ethyl alcohol, isopropyl alcohol and n-butyl alcohol; cellosolve based solvents such as methyl cellosolve, ethyl cellosolve, butyl cellosolve, methyl cellosolve acetate, ethyl cellosolve acetate, BCSA (butyl cellosolve acetate); NMP (N-methyl-2-pyrolidone); THF (tetrahydrofuran); DMF (dimethyl formamide); DMAC (dimethyl acetamide); DBE (dibasic acid ester); EEP (ethyl 3-ethoxypropionate); DMC (dimethyl carbonate); and the like.

Further, an amount of the solvent contained in the material for forming the spacer formation layer (liquid material) is preferably set to a value falling within such a range that an amount of the solid components mixed in the solvent (namely, the constituent material of the spacer formation layer 12) becomes about 10 to 60 wt %.

[2-2] Next, as shown in FIG. 2(c), the spacer formation layer 12 (bonding surface) of the spacer formation film 1 is attached to a surface of the semiconductor wafer 101′ on which the individual circuits 103 having the light receiving portions are provided (this step is referred to as a laminating step). In this way, the spacer formation layer 12 is attached to the semiconductor wafer 101′ so as to be located at the side of the individual circuits 103 having the light receiving portions in a state that it keeps the support base 11 at a side opposite to the semiconductor wafer 101′.

In this regard, for example, the attachment of the spacer formation layer 12 to the surface (upper surface) of the semiconductor wafer 101′ on which the side of the individual circuits 103 having the light receiving portions are provided can be carried out as follows.

First, the spacer formation film 1 is aligned with respect to the semiconductor wafer 101′, and then one end side of a lower surface of the spacer formation film 1 is contacted to one end side of an upper surface of the semiconductor wafer 101′.

Next, in this state, the spacer formation film 1 and the semiconductor wafer 101′ are set to a bonding machine so that a portion where the lower surface of the spacer formation film 1 is contacted to the upper surface of the semiconductor wafer 101′ is nipped by a pair of rollers. In this way, the spacer formation film 1 and the semiconductor wafer 101′ are compressed.

Next, the pair of rollers are moved from the one sides of the spacer formation film 1 and the semiconductor wafer 101′ to the other sides thereof. At this time, in a portion of the spacer formation film and the semiconductor wafer 101′ nipped by the rollers, the spacer formation layer 12 is sequentially bonded to the individual circuits 103 having the light receiving portions. As a result, the spacer formation layer 12 is attached (bonded) to the semiconductor wafer 101′.

A compression pressure when the spacer formation film 1 and the semiconductor wafer 101′ are nipped by the rollers is not limited to a specific value, but is preferably in the range of about 0.1 to 10 kgf/cm², and more preferably in the range of about 0.2 to 5 kgf/cm². This makes it possible for the spacer formation layer 12 to be reliably bonded to the individual circuits 103 having the light receiving portions.

A speed of moving each roller is not limited to a specific value, but is preferably in the range of about 0.1 to 1.0 m/min, and more preferably in the range of about 0.2 to 0.6 m/min.

Further, a heating means such as a heater is provided in each roller. Therefore, the portion of the spacer formation film 1 and the semiconductor wafer 101′ nipped by the rollers is heated. A heat temperature is preferably in the range of about 0 to 120° C., and more preferably in the range of about 40 to 100° C.

[3] Next, the spacer formation layer 12 formed on the semiconductor wafer 101′ is heated (this step is referred to as a PLB (Post Lamination Baking) step).

At this time, the spacer formation layer 12 positioned on steps of the individual circuits 103 having the light receiving portions can be fluid flowed. This makes it possible to make a surface of the spacer formation layer 12 more smooth.

A temperature of heating the spacer formation layer 12 is preferably in the range of about 20 to 120° C., and more preferably in the range of about 30 to 100° C.

Further, a time of heating the spacer formation layer 12 is preferably in the range of about 0.1 to 10 minutes, and more preferably in the range of about 2 to 7 minutes.

[4] Next, a region of the spacer formation layer 12 to be brought into the spacer 104 is exposed by being irradiated with light (this step is referred to as an exposure step).

In this way, in the spacer formation layer 12, the region to be brought into the spacer 104 is selectively photo cross-linked.

For example, the light irradiation to the region of the spacer formation layer 12 to be brought into the spacer 104 is carried out, as shown in FIG. 2(d), by irradiating the region with the light through a mask 20 having an opening portion 201 corresponding to the region.

In this regard, in this embodiment, the exposure of the spacer formation layer 12 is carried out through the support base 11. By exposing the spacer formation layer 12 in this way, it is possible to reliably expose the spacer formation layer 12, while effectively preventing dust or the like from involuntarily adhering to the spacer formation layer 12.

Further, in the case where the spacer formation layer 12 is exposed without the support base 11, there is a fear that flatness of the surface of the spacer formation layer 12 is lowered due to adhesion of the mask 20 thereto or there is a fear that a part of the previous spacer formation layer 12 adhering to the mask 20 is transferred (re-adheres) to the spacer formation layer 12 provided on the semiconductor wafer 101′ to be subsequently exposed.

However, by exposing the spacer formation layer 12 through the support base 11, it is also possible to obtain an advantage of effectively preventing the above problems.

A wavelength of the light, with which the spacer formation layer 12 is irradiated, is preferably in the range of about 150 to 700 nm, and more preferably in the range of about 150 to 450 nm.

Further, an integrated dose of the light, with which the spacer formation layer 12 is irradiated, is preferably in the range of about 200 to 3,000 mJ/cm², and more preferably in the range of about 300 to 2,500 mJ/cm².

[5] Next, the spacer formation layer 12 after the exposure is heated (this step is referred to as a PEB (Post Exposure Baking) step).

This makes it possible to more firmly cure the region of the spacer formation layer 12 to be brought into the spacer 104, and to more strongly bond the region of the spacer formation layer 12 to be brought into the spacer 104 to the individual circuits 103 having the light receiving portions. Further, this also makes it possible to a reduce residual stress of the spacer formation layer 12.

A temperature of heating the spacer formation layer 12 is preferably in the range of about 30 to 120° C., and more preferably in the range of about 30 to 100° C.

Further, a time of heating the spacer formation layer 12 is preferably in the range of about 1 to 10 minutes, and more preferably in the range of about 2 to 7 minutes.

[6] Next, the spacer formation layer 12 after the exposure is developed using an alkali solution (this step is referred to as a developing step).

By doing so, as shown in FIG. 2(e), a region of the spacer formation layer 12 not exposed is removed (etched), to thereby obtain a spacer 104 having air-gap portions 105 formed from the removed region. In other words, it is possible to obtain a spacer (spacer substrate) 104 formed from the exposed region.

In this regard, since the resin composition of the present invention has high sensitivity with respect to the light to be used in the step [4], it has an excellent patterning property. For this reason, in this step, it is possible to form a spacer 104 having a designed shape.

Further, in this embodiment, since the support base 11 is provided on the spacer formation layer 12, the support base 11 is removed from the spacer formation layer 12 prior to the development of the spacer formation layer 12.

pH of the alkali solution to be used is preferably 9.5 or more, and more preferably in the range of about 11.0 to 14.0. This makes it possible to effectively remove the spacer formation layer 12.

Examples of such an alkali solution include an aqueous solution of an alkali metal hydroxide such as NaOH or KOH, an aqueous solution of an alkali earth metal hydroxide such as Mg(OH)₂, an aqueous solution of tetramethyl ammonium hydroxide, an amide-type organic solvent such as N,N-dimethyl formamide (DMF) or N,N-dimethyl acetoamide (DMA) and the like. These alkali solutions are used alone or two or more of them are used in combination.

[7] Next, as shown in FIG. 3(a), a transparent substrate 102 is attached to the spacer 104 formed on the semiconductor wafer 101′. Namely, the transparent substrate 102 is attached to the semiconductor wafer 101′ through the spacer 104 (this step is referred to as an attaching step).

In this regard, for example, the transparent substrate 102 can be attached to the semiconductor wafer 101′ using the same method as described in the above step [2-2] in which the spacer formation film 1 is attached to the semiconductor wafer 101′.

[8] Next, the spacer 104 is thermal cured by heating the semiconductor wafer 101′ and the transparent substrate 102 in the state that they are bonded together through the spacer 104 (this step is referred to as a thermal curing step).

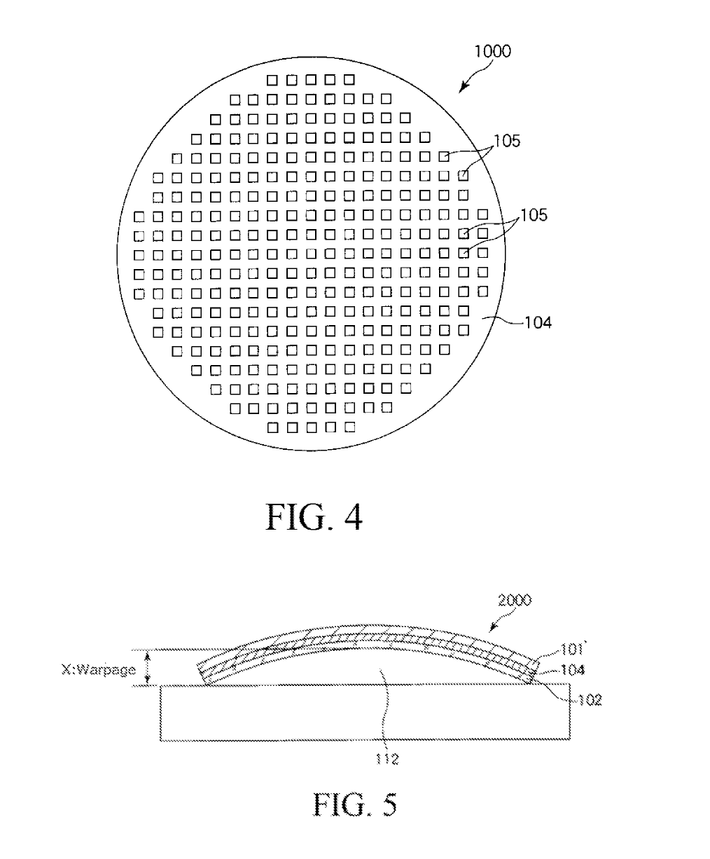

By doing so, the spacer 104 and the transparent substrate 102 are physically bonded together. As a result, it is possible to obtain a semiconductor wafer bonding product 1000 in which the semiconductor wafer 101′ and the transparent substrate 102 are bonded together through the spacer 104, that is, a semiconductor wafer bonding product 1000 having the plurality of air-gap portions 105 between the semiconductor wafer 101′ and the transparent substrate 102 (see FIG. 4).

A temperature of heating the spacer 104 is preferably in the range of about 80 to 180° C., and more preferably in the range of about 110 to 160° C. By heating the spacer 104 within the above temperature range, it is possible to make a shape of the formed spacer 104 appropriate.

[9] Next, as shown in FIG. 3(b), a lower surface (back side) 111 of the semiconductor wafer 101′ opposite to the transparent substrate 102′ bonded thereto is subjected to at least one of processes such as grinding and polishing (this step is referred to as a back grinding step).

This lower surface 111 is ground using, for example, a grinding disk of a grinding machine (grinder).

By the process of such a surface 111, a thickness of the semiconductor wafer 101′ is generally set to about 100 to 600 μm depending on an electronic device in which the semiconductor device 100 is used. In the case where the semiconductor device 100 is used in an electronic device having a smaller size, the thickness of the semiconductor wafer 101′ is set to about 50 μm.

If the thickness of the semiconductor wafer 101′ makes small in this way, warp which would occur in the semiconductor wafer bonding product 1000 becomes large as described above. This causes the following problems during a back side processing step [10] and a dicing step [11] which are post-steps.

Namely, the semiconductor wafer bonding product 1000 is passed through the back side processing step [10] and the dicing step [11] after this step [9].

The back side processing step [10] includes, for example, a process of laminating a photosensitive resist onto the semiconductor wafer bonding product 1000, a process of exposing the photosensitive resist and a process of developing the photosensitive resist.

Therefore, in the case where the semiconductor wafer bonding product 1000 is set to machines such as a laminator, an exposure machine (stepper), a developing machine and a dicing saw, the semiconductor wafer bonding product 1000 is received into a magazine case, and then the magazine case is set to the machines. At this time, if warpage of the semiconductor wafer bonding product 1000 has become large after the step [9], the semiconductor wafer bonding product 1000 can be not received into the magazine case, to thereby be not set to the machines. This causes a fault that the semiconductor wafer bonding product 1000 cannot be passed through the above post-steps.

Further, each machine transfers the semiconductor wafer bonding product 1000 or secures the semiconductor wafer bonding product 1000 onto a stage by sucking it. Therefore, even if the semiconductor wafer bonding product 1000 can be received into the magazine case, in the case where the warpage of the semiconductor wafer bonding product 1000 has become large by being back ground, the semiconductor wafer bonding product 1000 cannot be transferred or secured by being sucked. This also causes a fault that the back side processing step [10] and the dicing step [11] cannot be carried out.

In order to solve the above problems, in the present invention, a bonded body 2000 for identifying (measuring) a warpage of the semiconductor wafer bonding product is prepared, a warpage of the bonded body 2000 becomes 3,000 μm or less.

Here, in the present invention, the bonded body 2000 includes: a semiconductor wafer 101′ having a substantially circular shape, a diameter of 8 inches and a thickness of 725 μm; a transparent substrate 102 having a substantially circular shape, a diameter of 8 inches and a thickness of 350 μm; and a spacer 104 through which the semiconductor wafer 101′ and the transparent substrate 102 are bonded together, the spacer 104 formed on a substantially overall surface of the semiconductor wafer 101′ or the transparent substrate 102 (see FIG. 5).

Further, by subjecting the semiconductor wafer 101′ to a process for substantially uniformly grinding and/or polishing a lower surface 111 thereof, a thickness of the semiconductor wafer 101′ is set to one-fifth.

Further, from a relationship among the semiconductor wafer 101′, the transparent substrate 102 and the spacer 104 in a linear expansion coefficient, an elastic modulus and the like, when the bonded body 2000 is placed on a flat surface so that the transparent substrate 102 is located on the downside as shown in FIG. 5, a position of a central portion of transparent substrate 102 becomes higher than a position of an outer portion thereof, and thus a space (gap) 112 is formed between the flat surface and a surface of the transparent substrate 102.

In the present invention, a maximum height of the space 112 is defined as a warpage of the bonded body 2000.

If the warpage of such a bonded body 2000 is 3,000 μm or less, preferably 1,000 μm or less, and more preferably 500 μm or less (excluding 0 μm), it is possible to effectively suppress or prevent the semiconductor wafer bonding product 1000 from being not received into the machine for carrying out the below mentioned back side processing step [10] or dicing step [11] or from being broken by being hooked into the machine.

Further, in the present invention, it is preferred that a warpage of the semiconductor wafer bonding product 1000 before a lower surface 111 thereof is subjected to a process (grinding and/or polishing) is small and an increasing rate of the warpage of the semiconductor wafer bonding product 1000, which would occur by being subjected to the process, is suppressed.

Specifically, the bonded body 2000 for identifying the warpage of the semiconductor wafer bonding product is prepared, when the surface of the semiconductor wafer 101′ opposite to the spacer 104 is subjected to a process for substantially uniformly grinding and/or polishing it so that the semiconductor wafer 101′ has one-fifth thickness, it is preferred that the warpage of the bonded body 2000 before the process of the semiconductor wafer 101′ is 5,000 μm or less and that the increasing rate of the warpage of the bonded body 2000 after the process of the semiconductor wafer 101′ is suppressed to 600% or less.

In this regard, in the present invention, in the case where the warpage of the bonded body 2000 before the grinding of the lower surface 111 is defined as “A” and the warpage of the bonded body 2000 after the grinding of the lower surface 111 is defined as “B”, the increasing rate of the warpage of the bonded body 2000 is a value calculated by [(B−A)/A]×100(%).

The warpage of the bonded body 2000 before the process (grinding and/or polishing) thereof is preferably 500 μm or less, more preferably 400 μm or less, and even more preferably in the range of about 50 to 300 μm. Further, when the semiconductor wafer 101′ is processed so as to have one-fifth thickness, the increasing rate of the warpage of the bonded body 2000 becomes preferably 600% or less, more preferably 500% or less, and even more preferably 400% or less (excluding 0%).

By satisfying such relationships, since the warpage of the bonded body 2000 before the process thereof is reliably small and the increasing rate of the warpage of the bonded body 2000 after the process thereof is reliably suppressed, it is possible to effectively suppress or prevent the semiconductor wafer bonding product 1000 described below from being not received into the machine for carrying out the below mentioned back side processing step [10] or dicing step [11] or from being broken by being hooked into the machine.

Namely, by setting the warpage of the bonded body 2000 for identifying the warpage of the semiconductor wafer bonding product to a value falling within such a range, the warpage of the semiconductor wafer bonding product 1000 to be used as an actual product becomes a problem-free magnitude when carrying out the back side processing step [10] and the dicing step [11]. Therefore, it is possible to reliably suppress or prevent problems which would occur when the steps [10] and [11] are carried out.

As described above, in the present invention, the resin composition to be used for forming a spacer 104 having a grid-like shape at a planar view thereof is formed of the constituent material containing the alkali soluble resin, the thermosetting resin and the photo initiator, so that the warpage of the bonded body 2000 is 3,000 μm or less, and preferably so that the warpage of the bonded body 2000 before the process thereof is 500 μm or less and the increasing rate of the warpage of the bonded body 2000 after the process thereof is 6000 or less.

In this regard, it the present invention, a thickness of the spacer 104 of the bonded body 2000 is preferably in the range of about 20 to 80 μm, and more preferably about 50 μm.

Further, as the transparent substrate 102, a substrate having the same elastic modulus and linear expansion coefficient as those of the semiconductor wafer 101′ is appropriately selected. Specifically, as the transparent substrate 102, a substrate constituted from a silicon oxide-based material such as silica glass (quartz glass) or silica (crystal) is appropriately used.

In the case of the bonded body 2000 in which the thickness of the spacer 104 falls within the above range and the kind of the constituent material of the transparent substrate 102 is selected, in order to set so that the warpage thereof is 3,000 μm or less, and preferably so that the warpage before the process thereof is 500 μm or less and the increasing rate of the warpage after the process thereof is 600% or less, the constituent material of the resin composition to be used for forming the spacer 104 is adjusted.

As described above, the spacer formation layer 12 constituted from the resin composition containing the alkali soluble resin, the thermosetting resin and the photo initiator has I: the photo curable property that the region irradiated with the light is cured, II: the alkali developing property that the region not irradiated with the light is dissolved by the alkali solution and III: the thermal curable property that the region irradiated with the light is further cured by being heated, and IV: such a spacer formation layer 12 can suppress the warpage of the bonded body 2000 to 3,000 μm or less in a reliable manner.

Here, as the constituent material of the resin composition, preferably selected is a material which can appropriately exhibit the above properties “I” to “III” and can make the warpage of the bonded body 2000 described as “IV” small. Further, as the constituent material of the resin composition, more preferably selected is a material which can adjust the warpage of the bonded body 2000 before the process thereof to 500 μm or less and adjust the increasing rate of the warpage of the bonded body 2000 after the process thereof to 600% or less.

Hereinbelow, description will be made on each of components of the resin composition in detail.

(Alkali Soluble Resin)

The resin composition constituting the spacer formation layer 12 (that is, the resin composition of the present invention) contains the alkali soluble resin. This makes it possible for the spacer formation layer 12 to exhibit the alkali developing property.

Examples of the alkali soluble resin include: a phenol resin containing phenolic hydroxyl groups such as a cresol-type resin, a phenol-type resin, a bisphenol A-type resin, a bisphenol F-type resin, a catechol-type resin or a pyrogallol-type resin; a phenol aralkyl resin; a hydroxystyrene resin; an (meth)acrylate resin such as an acryl-based resin obtained by polymerizing (meth)acryl-type monomers each containing a hydroxyl group or a carboxyl group, an epoxy acrylate containing hydroxyl groups or carboxyl groups or an urethane acrylate; a cyclic olefin-based resin containing hydroxyl groups, carboxyl groups or the like; a polyamide-based resin; and the like. These alkali soluble resins may be used alone or in combination of two or more of them.

In this regard, concrete examples of the polyamide-based resin include: a resin containing at least one of a polybenzoxazole structure and a polyimide structure, and hydroxyl groups, carboxyl groups, ether groups or ester groups in a main chain or branch chains thereof; a resin containing a polybenzoxazole precursor structure; a resin containing a polyimide precursor structure; a resin containing a polyamide acid ester structure; and the like.

Examples of the (meth)acryl-type monomers to be used for synthesizing the acryl-based resin obtained by polymerizing (meth)acryl-type monomers each containing a hydroxyl group or a carboxyl group include 2-hydroxyethyl (meth)acrylate containing a hydroxyl group, (meth)acrylic acid containing a carboxyl group and the like. These monomers may be radical polymerized alone, but may be co-polymerized with a monomer having a double bond such as a (meth)acrylate monomer (e.g., methyl (meth)acrylate, ethyl (meth)acrylate, isopropyl (meth)acrylate or n-butyl (meth)acrylate, acrylonitrile containing a nitrile group, styrene, divinyl benzene or butadiene.

Among these alkali soluble resins, it is preferable to use an alkali soluble resin containing both alkali soluble groups, which contribute to the alkali developing, and double bonds.

Examples of the alkali soluble groups include a hydroxyl group, a carboxyl group and the like. The alkali soluble groups can also contribute to a thermal curing reaction in addition to the alkali developing. Further, since the alkali soluble resin contains the double bonds, it also can contribute to a photo curing reaction.

Examples of such a resin containing alkali soluble groups and double bonds include a curable resin which can be cured by both light and heat. Concrete examples of the curable resin include a thermosetting resin containing photo reaction groups such as an acryloyl group, a methacryloyl group and a vinyl group; a photo curable resin containing thermal reaction groups such as a phenolic hydroxyl group, an alcoholic hydroxyl group, a carboxyl group and an anhydride group; and the like.

In this regard, it is to be noted that the photo curable resin containing thermal reaction groups may further have other thermal reaction groups such as an epoxy group, an amino group and a cyanate group. Concrete examples of the photo curable resin having such a chemical structure include a (meth)acryl-modified phenol resin, a (meth)acryl-modified bisphenol A-type resin, an acryl acid polymer containing (meth)acryloyl groups, an (epoxy)acrylate containing carboxyl groups, a polybenzooxazole precursor resin containing double bonds, a polyimide precursor resin containing double bonds and the like. Further, the photo curable resin may be a thermoplastic resin such as an acryl resin containing carboxyl groups.

Among the above resins each containing alkali soluble groups and double bonds (that is, the curable resins which can be cured by both light and heat), it is preferable to use the (meth)acryl-modified phenol resin or the (meth)acryl-modified bisphenol A-type resin.

By using the (meth)acryl-modified phenol resin or the (meth)acryl-modified bisphenol A-type resin, since each resin contains the alkali soluble groups, when the resin which has not reacted is removed during a developing treatment, an alkali solution having less adverse effect on environment can be used as a developer instead of an organic solvent which is normally used. Further, since each resin contains the double bonds, these double bonds contribute to the curing reaction. As a result, it is possible to improve heat resistance of the resin composition.

Furthermore, by using the (meth)acryl-modified phenol resin or the (meth)acryl-modified bisphenol A-type resin, it is possible to reliably reduce the warpage of the bonded body 2000 before the process (grinding and/or polishing) of the semiconductor wafer 101′ and to effectively suppress the increasing rate of the warpage of the bonded body 2000 after the process (grinding and/or polishing) of the semiconductor wafer 101′. From the viewpoint of such a fact, it is also preferable to use the (meth)acryl-modified phenol resin or the (meth)acryl-modified bisphenol A-type resin.

Examples of the (meth)acryl-modified phenol resin or the (meth)acryl-modified bisphenol A-type resin include a (meth)acryloyl-modified bisphenol resin or a (meth)acryl-modified bisphenol A-type resin obtained by reacting hydroxyl groups contained in bisphenols or bisphenols with epoxy groups of compounds containing the epoxy groups and (meth)acryloyl groups.

Concretely, examples of such a (meth)acryl-modified bisphenol A-type resin include a resin represented by the following chemical formula I.

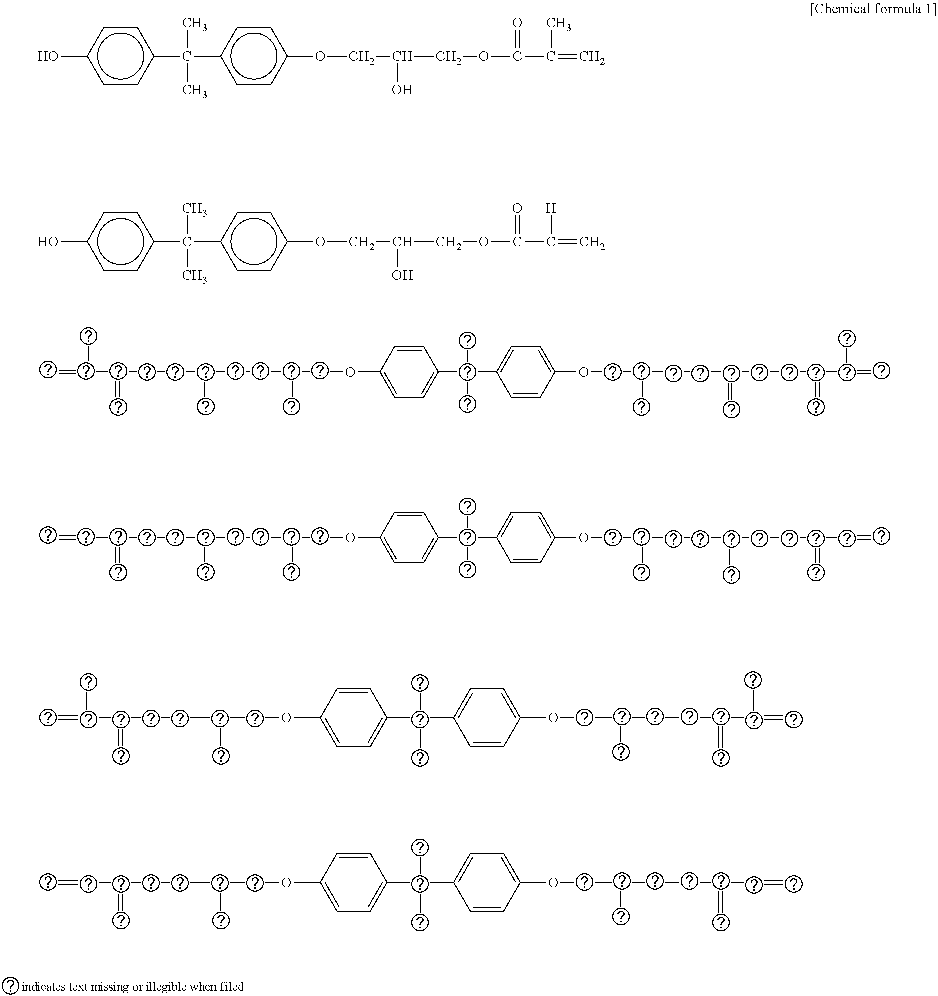

Further, as another resin containing alkali soluble groups and double bonds, exemplified is a compound introducing a dibasic acid into a molecular chain of a (meth)acryloyl-modified epoxy resin in which (meth) acryloyl groups are bonded to both ends of an epoxy resin, the compound obtained by bonding one of carboxyl groups of the dibasic acid to one hydroxyl group of the molecular chain of the (meth)acryloyl-modified epoxy resin via an ester bond. In this regard, it is to be noted that this compound has one or more repeating units of the epoxy resin and one or more dibasic acids introduced into the molecular chain.

Such a compound can be synthesized by reacting epoxy groups existing both ends of an epoxy resin obtained by polymerizing epichlorohydrin and polyalcohol with (meth)acrylic acid to obtain a (meth)acryloyl-modified epoxy resin in which acryloyl groups are introduced into both the ends of the epoxy resin, and then reacting hydroxyl groups of a molecular chain of the (meth)acryloyl-modified epoxy resin with an anhydride of a dibasic acid to form an ester bond together with one of carboxyl groups of the dibasic acid.

Here, in the case of using the thermosetting resin containing photo reaction groups, a modified ratio (substitutional ratio) of the photo reaction groups is not limited to a specific value, but is preferably in the range of about 20 to 80%, and more preferably about 30 to 70% with respect to total reaction groups of the resin containing alkali soluble groups and double bonds. If the modified ratio of the photo reaction groups falls within the above range, it is possible to provide a resin composition having an excellent developing property.

On the other hand, in the case of using the photo curable resin containing thermal reaction groups, a modified ratio (substitutional ratio) of the thermal reaction groups is not limited to a specific value, but is preferably in the range of about 20 to 80%, and more preferably in the range of about 30 to 70% with respect to total reaction groups of the resin containing alkali soluble groups and double bonds. If the modified ratio of the thermal reaction groups falls within the above range, it is possible to provide a resin composition having an excellent developing property.

Further, in the case where the resin having alkali soluble groups and double bonds is used as the alkali soluble resin, a weight-average molecular weight of the resin is not limited to a specific value, but is preferably 30,000 or less, and more preferably in the range of about 5,000 to 15,000. If the weight-average molecular weight falls within the above range, it is possible to further improve a film forming property of the resin composition in forming the spacer formation layer onto a film.

Here, the weight-average molecular weight of the alkali soluble rein can be measured using, for example, a gel permeation chromatographic method (GPC). That is, according to such a method, the weight-average molecular weight can be calculated based on a calibration curve which has been, in advance, made using styrene standard substances. In this regard, it is to be noted that the measurement is carried out using tetrahydrofuran (THF) as a measurement solvent at a measurement temperature of 40° C.

Further, an amount of the alkali soluble resin contained in the resin composition is not limited to a specific value, but is preferably in the range of about 15 to 50 wt %, and more preferably in the range of about 20 to 40 wt % with respect to a total amount of the resin composition. In this regard, in the case where the resin composition contains a filler described below, the amount of the alkali soluble resin may be preferably in the range of about 10 to 80 wt %, and more preferably in the range of about 15 to 70 wt % with respect to resin components contained in the resin composition (total components excluding the filler).

If the amount of the alkali soluble resin is less than the above lower limit value, there is a case that an effect of improving compatibility with other components (e.g., the photo curable resin and the thermosetting resin each described below) contained in the resin composition is lowered. On the other hand, if the amount of the alkali soluble resin exceeds the upper limit value, there is a fear that patterning resolution of the spacer formed by a photo lithography technique is lowered.

In other words, if the amount of the alkali soluble resin falls within the above range, it is possible for the resin composition patterned by the photo lithography technique to more reliably exhibit the thermal bonding property.

(Thermosetting Resin)

Further, the resin composition constituting the spacer formation layer 12 contains the thermosetting resin. This makes it possible for the spacer formation layer 12 to exhibit a bonding property due to curing thereof, even after it has been exposed and developed. Namely, after the spacer formation layer 12 has been bonded to the semiconductor wafer, and exposed and developed, the transparent substrate 10 can be bonded to the spacer formation layer 12 by thermal bonding.

In this regard, in the case where the curable resin which can be cured by heat is used as the above alkali soluble resin, a resin other than the curable resin is selected as the thermosetting resin.

Specifically, examples of the thermosetting resin include: a novolac-type phenol resin such as a phenol novolac resin, a cresol novolac resin and a bisphenol A novolac resin; a phenol resin such as a resol phenol resin; an epoxy resin such as a bisphenol-type epoxy resin (e.g., a bisphenol A epoxy resin, a bisphenol F epoxy resin), a novlolac-type epoxy resin (e.g., a novolac epoxy resin, a cresol novolac epoxy resin), a biphenyl-type epoxy resin, a stilbene-type epoxy resin, a triphenol methane-type epoxy resin, an alkyl-modified triphenol methane-type epoxy resin, a triazine chemical structure-containing epoxy resin, a dicyclopentadiene-modified phenol-type epoxy resin and an epoxy resin having naphthalene skeletons; an urea resin; a resin having triazine rings such as a melamine resin; an unsaturated polyester resin; a bismaleimide resin; a polyurethane resin; a diallyl phthalate resin; a silicone resin; a resin having benzooxazine rings; a cyanate ester resin; an epoxy-modified siloxane; and the like. These thermosetting resins may be used singly or in combination of two or more of them.

Among the thermosetting resins, it is preferable to use the epoxy resin. This makes it possible to improve heat resistance of the spacer formation layer and adhesion thereof to the transparent substrate 102. Further, this makes it possible to reliably reduce the warpage of the bonded body 2000. Furthermore, this also makes it possible to reliably reduce the warpage of the bonded body 2000 before the process (grinding and/or polishing) of the semiconductor wafer 101′ and to effectively suppress the increasing rate of the warpage of the bonded body 2000 after the process (grinding and/or polishing) of the semiconductor wafer 101′.

Furthermore, in the case of using the epoxy resin as the thermosetting resin, it is preferred that an epoxy resin in a solid state at room temperature (in particular, bisphenol-type epoxy resin) and an epoxy resin in a liquid state at room temperature (in particular, silicone-modified epoxy resin in a liquid state at room temperature) are used in combination as the epoxy resin. This makes it possible to obtain a spacer formation layer 12 having excellent flexibility and resolution, while maintaining heat resistance thereof.

An amount of the thermosetting resin contained in the resin composition is not limited to a specific value, but preferably in the range of about 10 to 40 wt %, and more preferably in the range of about 15 to 35 wt % with respect to the total amount of the resin composition. If the amount of the thermosetting resin is less than the above lower limit value, there is a case that an effect of improving the heat resistance of the spacer formation layer 12 after being thermally cured is lowered. On the other hand, if the amount of the thermosetting resin exceeds the above upper limit value, there is a case that an effect of improving toughness of the spacer formation layer 12 after being thermally cured is lowered.

Further, in the case of using the above epoxy resin, it is preferred that the thermosetting resin further contains the phenol novolac resin in addition to the epoxy resin. Addition of the phenol novolac resin makes it possible to improve the resolution of the spacer formation layer 12. Furthermore, in the case where the resin composition contains both the epoxy resin and the phenol novolac resin as the thermosetting resin, it is also possible to obtain an advantage that the thermal curable property of the epoxy resin can be further improved, to thereby make the strength of the spacer 104 to be formed higher.

(Photo Initiator)

The resin composition constituting the spacer formation layer 12 further contains the photo initiator. This makes it possible to more effectively pattern the spacer formation layer 12 due to photo polymerization thereof.

Examples of the photo initiator include benzophenone, acetophenone, benzoin, benzoin isobutyl ether, benzoin methyl benzoate, benzoin benzoic acid, benzoin methyl ether, benzyl phenyl sulfide, benzyl, dibenzyl, diacetyl and the like.

An amount of the photo initiator contained in the resin composition is not limited to a specific value, but is preferably in the range of about 0.5 to 5 wt %, and more preferably in the range of about 0.8 to 3.0 wt % with respect to the total amount of the resin composition. If the amount of the photo initiator is less than the above lower limit value, there is a fear that an effect of starting the photo polymerization of the spacer formation layer 12 cannot be sufficiently obtained. On the other hand, if the amount of the photo initiator exceeds the above upper limit value, reactivity of the spacer formation layer 12 is extremely improved, and therefore there is a fear that storage stability or resolution thereof is lowered.

(Photo Polymerizable Resin)

It is preferred that the resin composition constituting the spacer formation layer 12 also contains a photo polymerizable resin in addition to the above components. If the resin composition contains the photo polymerizable resin together with the above mentioned alkali soluble resin, it is possible to further improve a patterning property of the spacer formation layer 12 to be obtained.

In this regard, in the case where the curable resin which can be cured by light is used as the above alkali soluble resin, a resin other than the curable resin is selected as the photo polymerizable resin.

Examples of the photo polymerizable resin include: but are not limited to, an unsaturated polyester; a (meth)acryl-based compound such as a (meth)acryl-based monomer and a (meth)acryl-based oligomer each containing one or more acryloyl groups or one or more methacryloyl groups in one molecule thereof; a vinyl-based compound such as styrene; and the like. These photo polymerizable resins may be used alone or in combination of two or more of them.

Among them, an ultraviolet curable resin containing the (meth)acryl-based compound as a major component thereof is preferable. This is because a curing rate of the (meth)acryl-based compound is fast when being exposed (irradiated) with light, and therefore it is possible to appropriately pattern the resin with a relative small exposure amount.

Examples of the (meth)acryl-based compound include a monomer of an acrylic acid ester or methacrylic acid ester, and the like. Concretely, examples of the monomer include: a difunctional (meth)acrylate such as ethylene glycol di(meth)acrylate, 1,6-hexanediol di(meth)acrylate, glycerin di(meth)acrylate and 1,10-decanediol di(meth)acrylate; a trifunctional (meth)acrylate such as trimethylol propane tri(meth)acrylate and pentaerythritol tri(meth)acrylate; a tetrafunctional (meth)acrylate such as pentaerythritol tetra(meth)acrylate and ditrimethylol propane tetra(meth)acrylate; a hexafunctional (meth)acrylate such as dipentaerythritol hexa(meth)acrylate; and the like.

Among these (meth)acryl-based compounds, it is preferable to use a (meth)acryl-based polyfunctional monomer. This makes it possible for the spacer 104 to be obtained by exposing and developing the spacer formation layer 12 to exhibit excellent strength. As a result, a semiconductor device 100 provided with the spacer 104 can have a more superior shape keeping property.

Further, by using the (meth)acryl-based polyfunctional monomer, it is possible to reliably reduce the warpage of the bonded body 2000. Further, it is also possible to reliably reduce the warpage of the bonded body 2000 before the process (grinding and/or polishing) of the semiconductor wafer 101′ and to effectively suppress the increasing rate of the warpage of the bonded body 2000 after the process (grinding and/or polishing) of the semiconductor wafer 101′. From the viewpoint of such a fact, it is also preferable to use the (meth)acryl-based polyfunctional monomer.

In this regard, it is to be noted that, in the present specification, the (meth)acryl-based polyfunctional monomer means a monomer of a (meth)acrylic acid ester containing three or more acryloyl groups or methacryloyl groups.

Further, among the (meth)acryl-based polyfunctional monomers, it is more preferable to use the trifunctional (meth)acrylate or the tetrafunctional (meth)acrylate. This makes it possible to exhibit the above effects more remarkably.

In this regard, in the case of using the (meth)acryl-based polyfunctional monomer, it is preferred that the photo polymerizable resin further contains an epoxy vinyl ester resin. In this case, since the (meth)acryl-based polyfunctional monomer is reacted with the epoxy vinyl ester resin by radical polymerization when exposing the spacer formation layer 12, it is possible to more effectively improve the strength of the spacer 104 to be formed by being exposed and developed. On the other hand, it is possible to improve solubility of the non-exposed region of the spacer formation layer 12 with the alkali developer when developing it, to thereby reduce residues after the development.

Examples of the epoxy vinyl ester resin include 2-hydroxyl-3-phenoxypropyl acrylate, EPOLIGHT 40E methacryl addition product, EPOLIGHT 70P acrylic acid addition product, EPOLIGHT 200P acrylic acid addition product, EPOLIGHT 80MF acrylic acid addition product, EPOLIGHT 3002 methacrylic acid addition product, EPOLIGHT 3002 acrylic acid addition product, EPOLIGHT 1600 acrylic acid addition product, bisphenol A diglycidyl ether methacrylic acid addition product, bisphenol A diglycidyl ether acrylic acid addition product, EPOLIGHT 200E acrylic acid addition product, EPOLIGHT 400E acrylic acid addition product, and the like.

In the case where the photo polymerizable resin contains the (meth)acryl-based polyfunctional monomer, an amount of the (meth)acryl-based polyfunctional monomer contained in the resin composition is not limited to a specific value, but is preferably in the range of about 1 to 50 wt %, and more preferably in the range of about 5 to 25 wt % with respect to the total amount of the resin composition. This makes it possible to more effectively improve the strength of the spacer formation layer 12 after being exposed, that is, the spacer 104, and thus to more effectively improve the shape keeping property thereof when the transparent substrate 102 is bonded to the semiconductor wafer 101′.

Further, in the case where the photo polymerizable resin contains the epoxy vinyl ester resin in addition to the (meth)acryl-based polyfunctional monomer, an amount of the epoxy vinyl ester resin is not limited to a specific value, but is preferably in the range of about 3 to 30 wt %, and more preferably in the range of about 5 to 15 wt % with respect to the total amount of the resin composition. This makes it possible to more effectively reduce a residual ratio of residues attached to each surface of the semiconductor wafer and transparent substrate after the transparent substrate is bonded to the semiconductor wafer.

Furthermore, it is preferred that the above photo polymerizable resin is of a liquid state at normal temperature. This makes it possible to further improve curing reactivity of the spacer formation layer by light irradiation (e.g., by ultraviolet ray irradiation). In addition, it is possible to easily mix the photo polymerizable resin with the other components (e.g., the alkali soluble resin). Examples of the photo polymerizable resin in the liquid form at the normal temperature include the above ultraviolet curable resin containing the (meth)acryl-based compound as the major component thereof, and the like.

In this regard, it is to be noted that a weight-average molecular weight of the photo polymerizable resin is not limited to a specific value, but is preferably 5,000 or less, and more preferably in the range of about 150 to 3,000. If the weight-average molecular weight falls within the above range, sensitivity of the spacer formation layer 12 becomes specifically higher. Further, the spacer formation layer 12 can also have superior resolution.

Here, the weight-average molecular weight of the photo polymerizable resin can be measured using the gel permeation chromatographic method (GPC), and is calculated in the same manner as described above.

(Dissolution Accelerator)

The resin composition to be used for forming the spacer formation layer 12 may contain a dissolution accelerator. As the dissolution accelerator, a compound including a hydroxyl group or a carboxyl group is exemplified, phenols or a phenol resin is especially preferable.

By adding the phenols or the phenol resin into the resin composition, a concentration of phenolic hydroxyl groups contained therein is increased. This makes it possible to improve resolvability of the resin composition by the alkali developer. After the phenols or the phenol resin functions as the dissolution accelerator of the resin composition by the alkali developer, it is introduced into a matrix of a cured product of the thermosetting resin. Therefore, it is possible to suppress members to be bonded such as the transparent substrate and the semiconductor wafer from being contaminated and to prevent heat resistance and moisture resistance from being lowered.

(Inorganic Filler)

In this regard, it is to be noted that the resin composition constituting the spacer formation layer 12 may also contain an inorganic filler. This makes it possible to further improve the strength of the spacer 104 to be formed from the spacer formation layer 12.

However, in the case where an amount of the inorganic filler contained in the resin composition becomes too large, raised are problems such as adhesion of foreign substances derived from the inorganic filler onto the semiconductor wafer 101′ and occurrence of undercut after developing the spacer formation layer 12. For this reason, it is preferred that the amount of the inorganic filler contained in the resin composition is 9 wt % or less with respect to the total amount of the resin composition.

Further, in the case where the resin composition contains the (meth)acryl-based polyfunctional monomer as the photo polymerizable resin, since it is possible to sufficiently improve the strength of the spacer 104 to be formed by exposing and developing the spacer formation layer 12 due to the addition of the (meth)acryl-based polyfunctional monomer, the addition of the inorganic filler to the resin composition can be omitted.

Examples of the inorganic filler include: a fibrous filler such as an alumina fiber and a glass fiber; a needle filler such as potassium titanate, wollastonite, aluminum borate, needle magnesium hydroxide and whisker; a platy filler such as talc, mica, sericite, a glass flake, scaly graphite and platy calcium carbonate; a globular (granular) filler such as calcium carbonate, silica, fused silica, baked clay and non-baked clay; a porous filler such as zeolite and silica gel; and the like. These inorganic fillers may be used alone or in combination of two or more of them. Among them, it is preferable to use the porous filler.

An average particle size of the inorganic filler is not limited to a specific value, but is preferably in the range of about 0.01 to 90 μm, and more preferably in the range of about 0.1 to 40 μm. If the average particle size exceeds the upper limit value, there is a fear that appearance and resolution of the spacer formation layer 12 are lowered. On the other hand, if the average particle size is less than the above lower limit value, there is a fear that the transparent substrate 102 cannot be reliably bonded to the spacer 104 even by the thermal bonding.

In this regard, it is to be noted that the average particle size is measured using, for example, a particle size distribution measurement apparatus of a laser diffraction type (“SALD-7000” produced by Shimadzu Corporation).

Further, in the case where the porous filler is used as the inorganic filler, an average hole size of the porous filler is preferably in the range of about 0.1 to 5 nm, and more preferably in the range of about 0.3 to 1 nm.

Here, by constituting the resin composition from the above mentioned constituent material, an elastic modulus at 25° C. of the spacer 104 formed of such a resin composition can be set preferably in the range of about 0.1 to 15 GPa, and more preferably in the range of about 1 to 7 GPa. If the elastic modulus of the spacer 104 falls within the above range, it is possible to more reliably set the warpage of the bonded body 2000 to 3,000 μm or less.

Further, it is also possible to set the warpage of the bonded body 2000 before the process (grinding and/or polishing) thereof to 500 μm or less and to set the increasing rate of the warpage of the bonded body 2000 after the process thereof to 6000 or less.

For example, the elastic modulus at 25° C. can be obtained by measuring the elastic modulus of the resin composition using a dynamic viscoelasticity apparatus (“RSA3” produced by TA Instruments) at a temperature range of −30 to 200° C., at a temperature rising speed of 5° C./min and at a frequency of 10 Hz, and reading a value of the elastic modulus measured at 25° C.

Further, by constituting the resin composition from the above mentioned constituent material, an average linear expansion coefficient at a temperature range of 0 to 30° C. of the spacer 104 formed of such a resin composition can be set preferably in the range of about 20 to 150 ppm/° C., and more preferably in the range of about 50 to 100 ppm/° C. If the linear expansion coefficient of the spacer 104 falls within the above range, it is possible to more reliably set the warpage of the bonded body 2000 to 3,000 μm or less.

Further, it is also possible to set the warpage of the bonded body 2000 before the process (grinding and/or polishing) thereof to 500 μm or less and to set the increasing rate of the warpage of the bonded body 2000 after the process thereof to 600% or less.

For example, the average linear expansion coefficient at 0 to 30° C. can be obtained by measuring a dimensional change amount of a measuring sample using a linear expansion coefficient measuring apparatus (“TMA/SS6000, EXSTAR6000” produced by Seiko Instruments Inc.) at −30 to 200° C. and at a temperature rising speed of 5° C./min, and then comparing the dimensional change amount of the measuring sample at 0 to 30° C. with a size of the measuring sample before the measurement.

Furthermore, by constituting the resin composition from the above mentioned constituent material, the elastic modulus and the linear expansion coefficient of the spacer 104 formed of such a resin composition can be set to a value falling within the above range. Therefore, a residual stress at 25° C. of the spacer 104 can be set preferably in the range of about 0.1 to 150 MPa, and more preferably in the range of about 0.1 to 100 MPa. If the residual stress of the spacer 104 falls within the above range, it is possible to more reliably set the warpage of the bonded body 2000 to 3,000 μm or less.

Further, it is also possible to set the warpage of the bonded body 2000 before the process (grinding and/or polishing) thereof to 500 μm or less and to set the increasing rate of the warpage of the bonded body 2000 after the process thereof to 600% or less.

For example, the residual stress at 25° C. can be obtained by forming a resin layer onto a bare silicon wafer having 8 inches (e.g., by laminating a resin film onto the bare silicon wafer so that the resin film is attached to the bare silicon wafer, by spin-coating a liquid resin onto the bare silicon wafer and then drying it, or by printing the liquid resin onto the bare silicon wafer), exposing the resin layer with a light having a wavelength of 365 nm under the condition of 1,000 mJ/cm², thermally curing it under the conditions of 180° C. and 2 hours to prepare an evaluation sample, measuring warpage of the evaluation sample using a surface roughness shape measuring apparatus (“SURFCOM1400D” produced by TOKYO SEIMITSU CO., LTD.), and then carrying out calculation based on the following formulas (1) and (2).

R=(a²+4X²)/8X (1)

σ=[D²E/{6Rt(1−υ)}]×9.8 (2)

where “X” is the warpage (mm), “a” is a measuring strength (mm), “R” is a radius of curvature (mm), “D” is a thickness of the bare silicon wafer (mm), “E” is an elastic modulus of silicon (16,200 kg/mm²), “t” is a thickness of the resin layer (mm), “υ” is Poisson's ratio (0.3) and “σ” is a residual stress (MPa), respectively.

In this regard, this step [9] in which the lower surface 111 of the semiconductor wafer 101′ is processed (ground and/or polished) may be carried out prior to the thermal curing step [8].

[10] Next, the lower surface (back side) 111 of the semiconductor wafer 101′, which has been ground and/or polished, is further subjected to a process (this step is referred to as a back side processing step).

Examples of such a process include formation of a circuit (wiring) on the lower surface 111, connection of the solder bumps 106 shown in FIG. 3(c) on the lower surface 111 and the like.

[11] Next, the semiconductor wafer bonding product 1000 is diced so as to correspond to each individual circuit formed on the semiconductor wafer 101′, that is, each air-gap portion 105 defined by the spacer 104, to thereby obtain a plurality of semiconductor devices 100 (this step is referred to as a dicing step).

For example, the dicing of the semiconductor wafer bonding product is carried out by forming grooves 21 from a side of the transparent substrate 102 using a dicing saw along the area where the spacer 104 is formed, and then also forming grooves 21 from a side of the semiconductor wafer 101′ using the dicing saw so as to correspond to the grooves 21.

Through the above steps, the semiconductor device 100 can be manufactured.

In this way, by dicing the semiconductor wafer bonding product 1000 to thereby obtain the plurality of semiconductor devices 100 at the same time, it is possible to mass-produce the semiconductor devices 100, and thus to improve productive efficiency thereof.

In this regard, for example, by mounting the semiconductor device 100 on a substrate provided with a circuit (patterned wiring), the circuit formed on the substrate is electrically connected to the circuit formed on the lower surface of the base substrate 101 via the solder bumps 106.

Further, the semiconductor device 100 mounted on the support substrate as described above can be widely used in electronics such as a cellular telephone, a digital camera, a video camera and a miniature camera.

In this regard, in this embodiment, the PLB step [3] in which the spacer formation layer 12 is heated after itself has been formed and the PEB step [5] in which the spacer formation layer 12 is heated after itself has been exposed are carried out, but these steps may be omitted depending on the kinds of the resin composition constituting the spacer formation layer 12 (that is, the resin composition of the present invention).

Further, the semiconductor wafer bonding product 1000 may be heated after the back grinding step [9] in which the lower surface 111 of the semiconductor wafer 101′ is ground. By heating the semiconductor wafer bonding product 1000 after the back grinding step [9], it is possible to reliably reduce the residual stress existing in the spacer 104, to thereby effectively suppress the warpage of the semiconductor wafer bonding product 1000.

While the resin composition, the semiconductor wafer bonding product and the semiconductor device of the present invention have been described hereinabove, the present invention is not limited thereto.

For example, the resin composition of the present invention also can contain other components in addition to the above mentioned components insofar as the purpose of the present invention is not spoiled. Examples of the other components include a plastic resin, a leveling agent, a defoaming agent or a coupling agent and the like.

### EXAMPLES

Hereinafter, description will be made on concrete examples of the present invention.

[1] Manufacture of Semiconductor Wafer Bonding Product

In each of the following Examples and Comparative Examples, 5 bonded bodies and 5 semiconductor wafer bonding products were manufactured as follows.

### Example 1

### 1. Synthesis of Alkali Soluble Resin

### Methacryloyl-Modified Bisphenol A Novolac Resin: MPN001

500 g of a MEK (methyl ethyl ketone) solution containing a novolac-type bisphenol A resin (“Phenolite LF-4871” produced by DIC corporation) with a solid content of 60 wt % was added into a 2 L flask. Thereafter, 1.5 g of tributylamine as a catalyst and 0.15 g of hydroquinone as a polymerization inhibitor were added into the flask, and then they were heated at 100° C. Next, 180.9 g of glycidyl methacrylate was further added into the flask in drop by drop for 30 minutes, and then they were reacted with each other by being stirred for 5 hours at 100° C., to thereby obtain a methacryloyl-modified bisphenol A novolac resin (methacryloyl modified ratio: 50%) with a solid content of 74%.

### 2. Preparation of Resin Varnish Containing Resin Composition Constituting Spacer Formation Layer

30.0 wt % of the solid content of the above methacryloyl-modified bisphenol A novolac resin (MPN001) as an alkali soluble resin; 19.0 wt % of a cresol novolac-type epoxy resin (“EPICLON N-665” produced by DIC Corporation) and 5.0 wt % of a siloxane-modified epoxy resin (“BY16-115” produced by Dow Corning Toray Co., Ltd.) as a thermosetting resin (epoxy resin); 10.0 wt % of ethylene glycol dimethacrylate (“NK Ester A-200” produced by Shin-Nakamura Chemical Co., Ltd.) as a photo polymerizable resin; and 35.0 wt % of spherical silica having an average particle size of 0.33 μm and a maximum particle size of 0.8 μm (“SFP-20M” produced by DENKI KAGAKU KOGYO KABUSHIKI KAISHA) as an inorganic filler were weighed, and methyl ethyl ketone (“MEK” produced by DAISHIN CHEMICAL CO., LTD.) was added thereto so that an amount (concentration) of the resin components contained in a resin varnish finally obtained was adjusted to 71 wt %.

Thereafter, the above components were stirred until the cresol novolac-type resin (EPICLON N-665) was dissolved thereinto.

Next, the silica was dispersed thereinto using a bead mill mixer (bead diameter: 400 μm, processing speed: 6 g/s, 5 passes).

Next, 1.0 wt % of benzyl dimethyl ketal (“IRGACURE 651” produced by Ciba Specialty Chemicals) as a photo initiator was added thereinto, and they were stirred using a stirring blade (450 rpm) for 1 hour, to obtain a resin varnish.

### 3. Production of Spacer Formation Film

First, prepared was a polyester film having a thickness of 50 μm (“MRX 50” produced by Mitsubishi Plastics, Inc.) as a support base.

Next, the above prepared resin varnish was applied onto the support base using a konma coater “MGF No. 194001 type 3-293” produced by YASUI SEIKI) to form a coating film constituted from the resin varnish. Thereafter, the formed coating film was dried under the conditions of 80° C. for 20 minutes to form a spacer formation layer. In this way, the spacer formation film was obtained. In the obtained spacer formation film, an average thickness of the spacer formation layer was 50 μm.

### 4. Manufacture of Bonded Body for Measuring Warpage

First, prepared was a semiconductor wafer having a substantially circular shape and a diameter of 8 inches (Si wafer, diameter: 20.3 cm, thickness: 725 μm).

Next, the above produced spacer formation film was laminated on the semiconductor wafer using a roll laminator under the conditions in which a roll temperature was 60° C., a roll speed was 0.3 m/min and a syringe pressure was 2.0 kgf/cm², to thereby obtain the semiconductor wafer with the spacer formation film.

Next, the semiconductor wafer with the spacer formation film was irradiated with an ultraviolet ray (wavelength: 365 nm, integrated dose: 700 mJ/cm²) from a side of the spacer formation film so that the entirety of the spacer formation layer at a planar view thereof was exposed, and then the support base was removed therefrom.

Next, prepared was a transparent substrate (quartz glass substrate, diameter: 20.3 mm, thickness: 350 μm). This transparent substrate was bonded to the semiconductor wafer, on which a spacer had been formed, by compression bonding using a substrate bonder (“SB8e” produced by Suss Microtec k.k.). In this way, manufactured was a bonded body in which the transparent substrate was bonded to the semiconductor wafer through the spacer.

### 5. Manufacture of Semiconductor Wafer Bonding Product

First, prepared was a semiconductor wafer having a substantially circular shape and a diameter of 8 inches (Si wafer, diameter: 20.3 cm, thickness: 725 μm).

Next, the above produced spacer formation film was laminated on the semiconductor wafer using a roll laminator under the conditions in which a roll temperature was 60° C., a roll speed was 0.3 m/min and a syringe pressure was 2.0 kgf/cm², to thereby obtain the semiconductor wafer with the spacer formation film.

Next, the semiconductor wafer with the spacer formation film was selectively irradiated with an ultraviolet ray (wavelength: 365 nm, integrated dose: 700 mJ/cm²) from a side of the spacer formation film so that the spacer formation layer was exposed in a grid pattern at a planar view thereof, and then the support base was removed therefrom. In this regard, it is to be noted that when exposing the spacer formation layer, 50% of the spacer formation layer was exposed in a planar view thereof so that a width of a region to be exposed in the grid pattern became 0.6 mm.

Next, the exposed spacer formation layer was developed using 2.38 wt % of tetramethyl ammonium hydroxide (TMAH) aqueous solution as a developer (alkali solution) under the conditions in which a developer pressure was 0.3 MPa and a developing time was 90 seconds. In this way, formed was a spacer composed of ribs each having a width of 0.6 mm onto the semiconductor wafer.

Next, prepared was a transparent substrate (quartz glass substrate, diameter: 20.3 mm, thickness: 350 μm). This transparent substrate was bonded to the semiconductor wafer, on which the spacer had been formed, by compression bonding using a substrate bonder (“SB8e” produced by Suss Microtec k.k.). In this way, manufactured was a semiconductor wafer bonding product in which the transparent substrate was bonded to the semiconductor wafer through the spacer.

The obtained semiconductor wafer bonding product before a process (grinding) thereof was placed on a flat surface so that the transparent substrate is located on the downside, and then a warpage thereof was measured.

### 6. Back Grinding of Semiconductor Wafer Bonding Product

The semiconductor wafer of the semiconductor wafer bonding product was ground using a grinder (“DFG8540” produced by DISCO Corporation) so that a thickness of a central portion of the semiconductor wafer became 145 μm.

Thereafter, the semiconductor wafer bonding product after the process (grinding) thereof was also placed on the flat surface so that the transparent substrate is located on the downside, and then the warpage thereof was measured.

### 7. Dicing of Semiconductor Wafer Bonding Product

The ground semiconductor wafer bonding product was diced using a dicing saw (“DFD6450” produced by DISCO Corporation) to separate into chips each having a size of 7 mm×8 mm.

In this regard, it is to be noted that in the obtained semiconductor wafer bonding product, an elastic modulus at 25° C. of the spacer was 7.8 GPa, an average linear expansion coefficient at 0 to 30° C. thereof was 68 ppm/° C. and a residual stress at 25° C. thereof was 16 MPa.

### Example 2

Bonded bodies and semiconductor wafer bonding products were manufactured in the same manner as Example 1, except that the preparation of the resin varnish (that is, the above step “2.”) was carried out as follows.

40.0 wt % of the solid content the above methacryloyl-modified bisphenol A novolac resin (MPN001) as the alkali soluble resin; 19.0 wt % of the cresol novolac-type epoxy resin (“EPICLON N-665” produced by DIC Corporation) and 3.0 wt % of the siloxane-modified epoxy resin (“BY16-115” produced by Dow Corning Toray Co., Ltd.) as the thermosetting resin (epoxy resin); 2.0 wt % of a phenol novolac resin (“PR-HF-6” produced by Sumitomo Bakelite Co., Ltd.); 10.0 wt % of the ethylene glycol dimethacrylate (“NK Ester A-200” produced by Shin-Nakamura Chemical Co., Ltd.) as the photo polymerizable resin; and 25.0 wt % of the spherical silica having the average particle size of 0.33 μm and the maximum particle size of 0.8 μm (“SFP-20M” produced by DENKI KAGAKU KOGYO KABUSHIKI KAISHA) as the inorganic filler were weighed, and the methyl ethyl ketone (“MEK” produced by DAISHIN CHEMICAL CO., LTD.) was added thereto so that an amount (concentration) of the resin components contained in a resin varnish finally obtained is adjusted to 71 wt %.

Thereafter, the above components were stirred until the cresol novolac-type resin (EPICLON N-665) was dissolved thereinto.

Next, the silica was dispersed thereinto using the bead mill mixer (bead diameter: 400 μm, processing speed: 6 g/s, 5 passes).

Next, 1.0 wt % of the benzyl dimethyl ketal (“IRGACURE 651” produced by Ciba Specialty Chemicals) as the photo initiator was added thereinto, and they were stirred using the stirring blade (450 rpm) for 1 hour, to obtain a resin varnish.

In this regard, it is to be noted that in the obtained semiconductor wafer bonding product, the elastic modulus at 25° C. of the spacer was 3.0 GPa, the average linear expansion coefficient at 0 to 30° C. thereof was 70 ppm/° C. and the residual stress at 25° C. thereof was 16 MPa.

### Example 3

Bonded bodies and semiconductor wafer bonding products were manufactured in the same manner as Example 1, except that the preparation of the resin varnish (that is, the above step “2.”) was carried out as follows.

55.0 wt % of the solid content of the above methacryloyl-modified bisphenol A novolac resin (MPN001) as the alkali soluble resin; 15.0 wt % of the cresol novolac-type epoxy resin (“EPICLON N-665” produced by DIC Corporation) and 5.0 wt % of the siloxane-modified epoxy resin (“BY16-115” produced by Dow Corning Toray Co., Ltd.) as the thermosetting resin (epoxy resin); 7.0 wt % of the phenol novolac resin (“PR-HF-6” produced by Sumitomo Bakelite Co., Ltd.); and 17.0 wt % of trimethylol propane trimethacrylate (“NK Ester A-TMP” produced by Shin-Nakamura Chemical Co., Ltd.) as the photo polymerizable resin were weighed, and the methyl ethyl ketone (“MEK” produced by DAISHIN CHEMICAL CO., LTD.) was added thereto so that an amount (concentration) of the resin components contained in a resin varnish finally obtained is adjusted to 71 wt %.

Thereafter, the above components were stirred until the cresol novolac-type resin (EPICLON N-665) was dissolved thereinto.

Next, 1.0 wt % of the benzyl dimethyl ketal (“IRGACURE 651” produced by Ciba Specialty Chemicals) as the photo initiator was added thereinto, and they were stirred using the stirring blade (450 rpm) for 1 hour, to obtain a resin varnish.

In this regard, it is to be noted that in the obtained semiconductor wafer bonding product, the elastic modulus at 25° C. of the spacer was 2.4 GPa, the average linear expansion coefficient at 0 to 30° C. thereof was 84 ppm/° C. and the residual stress at 25° C. thereof was 18 MPa.

### Example 4

Bonded bodies and semiconductor wafer bonding products were manufactured in the same manner as Example 1, except that the preparation of the resin varnish (that is, the above step “2.”) was carried out as follows.

45.0 wt % of the solid content of the above methacryloyl-modified bisphenol A novolac resin (MPN001) as the alkali soluble resin; 27.0 wt % of the cresol novolac-type epoxy resin (“EPICLON N-665” produced by DIC Corporation) and 3.0 wt % of the siloxane-modified epoxy resin (“BY16-115” produced by Dow Corning Toray Co., Ltd.) as the thermosetting resin (epoxy resin); and 23.0 wt % of the tetramethylol methane tetraacrylate (“NK Ester A-TMMT” produced by Shin-Nakamura Chemical Co., Ltd.) as the photo polymerizable resin were weighed, and the methyl ethyl ketone (“MEK” produced by DAISHIN CHEMICAL CO., LTD.) was added thereto so that an amount (concentration) of the resin components contained in a resin varnish finally obtained is adjusted to 71 wt %.

Thereafter, the above components were stirred until the cresol novolac-type resin (EPICLON N-665) was dissolved thereinto.

Next, 2.0 wt % of the benzyl dimethyl ketal (“IRGACURE 651” produced by Ciba Specialty Chemicals) as the photo initiator was added thereinto, and they were stirred using the stirring blade (450 rpm) for 1 hour, to obtain a resin varnish.

In this regard, it is to be noted that in the obtained semiconductor wafer bonding product, the elastic modulus at 25° C. of the spacer was 5.1 GPa, the average linear expansion coefficient at 0 to 30° C. thereof was 95 ppm/° C. and the residual stress at 25° C. thereof was 63 MPa.

### Example 5

Bonded bodies and semiconductor wafer bonding products were manufactured in the same manner as Example 1, except that the preparation of the resin varnish (that is, the above step “2.”) was carried out as follows.

45.0 wt % of the solid content of the above methacryloyl-modified bisphenol A novolac resin (MPN001) as the alkali soluble resin; 30.0 wt % of the cresol novolac-type epoxy resin (“EPICLON N-665” produced by DIC Corporation) and 8.0 wt % of the siloxane-modified epoxy resin (“BY16-115” produced by Dow Corning Toray Co., Ltd.) as the thermosetting resin (epoxy resin); and 15.0 wt % of the tetramethylol methane tetraacrylate (“NK Ester A-TMMT” produced by Shin-Nakamura Chemical Co., Ltd.) as the photo polymerizable resin were weighed, and the methyl ethyl ketone (“MEK” produced by DAISHIN CHEMICAL CO., LTD.) was added thereto so that an amount (concentration) of the resin components contained in a resin varnish finally obtained is adjusted to 71 wt %.

Thereafter, the above components were stirred until the cresol novolac-type resin (EPICLON N-665) was dissolved thereinto.

Next, 2.0 wt % of the benzyl dimethyl ketal (“IRGACURE 651” produced by Ciba Specialty Chemicals) as the photo initiator was added thereinto, and they were stirred using the stirring blade (450 rpm) for 1 hour, to obtain a resin varnish.

In this regard, it is to be noted that in the obtained semiconductor wafer bonding product, the elastic modulus at 25° C. of the spacer was 4.5 GPa, the average linear expansion coefficient at 0 to 30° C. thereof was 91 ppm/° C. and the residual stress at 25° C. thereof was 32 MPa.

### Example 6

Bonded bodies and semiconductor wafer bonding products were manufactured in the same manner as Example 1, except that the preparation of the resin varnish (that is, the above step “2.”) was carried out as follows.

45.0 wt % of the solid content of the above methacryloyl-modified bisphenol A novolac resin (MPN001) as the alkali soluble resin; 30.0 wt % of the cresol novolac-type epoxy resin (“EPICLON N-665” produced by DIC Corporation) and 8.0 wt % of the siloxane-modified epoxy resin (“BY16-115” produced by Dow Corning Toray Co., Ltd.) as the thermosetting resin (epoxy resin); and 15.0 wt % of dipentaerythritol hexaacrylate (“LIGHT-ACRYLATE DPE-6A” produced by KYOEISHA CHEMICAL Co., LTD.) as the photo polymerizable resin were weighed, and the methyl ethyl ketone (“MEK” produced by DAISHIN CHEMICAL CO., LTD.) was added thereto so that an amount (concentration) of the resin components contained in a resin varnish finally obtained is adjusted to 71 wt %.

Thereafter, the above components were stirred until the cresol novolac-type resin (EPICLON N-665) was dissolved thereinto.

Next, 2.0 wt % of the benzyl dimethyl ketal (“IRGACURE 651” produced by Ciba Specialty Chemicals) as the photo initiator was added thereinto, and they were stirred using the stirring blade (450 rpm) for 1 hour, to obtain a resin varnish.

In this regard, it is to be noted that in the obtained semiconductor wafer bonding product, the elastic modulus at 25° C. of the spacer was 3.8 GPa, the average linear expansion coefficient at 0 to 30° C. thereof was 89 ppm/° C. and the residual stress at 25° C. thereof was 43 MPa.

### Example 7

Bonded bodies and semiconductor wafer bonding products were manufactured in the same manner as Example 1, except that the preparation of the resin varnish (that is, the above step “2.”) was carried out as follows.

45.0 wt % of the solid content of the above methacryloyl-modified bisphenol A novolac resin (MPN001) as the alkali soluble resin; 30.0 wt % of the cresol novolac-type epoxy resin (“EPICLON N-665” produced by DIC Corporation) and 8.0 wt % of the siloxane-modified epoxy resin (“BY16-115” produced by Dow Corning Toray Co., Ltd.) as the thermosetting resin (epoxy resin); and 15.0 wt % of the ethylene glycol dimethacrylate (“NK Ester A-200” produced by Shin-Nakamura Chemical Co., Ltd.) as the photo polymerizable resin were weighed, and the methyl ethyl ketone (“MEK” produced by DAISHIN CHEMICAL CO., LTD.) was added thereto so that an amount (concentration) of the resin components contained in a resin varnish finally obtained is adjusted to 71 wt %.

Thereafter, the above components were stirred until the cresol novolac-type resin (EPICLON N-665) was dissolved thereinto.

Next, 2.0 wt % of the benzyl dimethyl ketal (“IRGACURE 651” produced by Ciba Specialty Chemicals) as the photo initiator was added thereinto, and they were stirred using the stirring blade (450 rpm) for 1 hour, to obtain a resin varnish.

In this regard, it is to be noted that in the obtained semiconductor wafer bonding product, the elastic modulus at 25° C. of the spacer was 1.4 GPa, the average linear expansion coefficient at 0 to 30° C. thereof was 93 ppm/° C. and the residual stress at 25° C. thereof was 23 MPa.

### Example 8

Bonded bodies and semiconductor wafer bonding products were manufactured in the same manner as Example 1, except that the preparation of the resin varnish (that is, the above step “2.”) was carried out as follows.

20.0 wt % of the solid content of the above methacryloyl-modified bisphenol A novolac resin (MPN001) as the alkali soluble resin; 14.0 wt % of the cresol novolac-type epoxy resin (“EPICLON N-665” produced by DIC Corporation) and 3.0 wt % of the siloxane-modified epoxy resin (“BY16-115” produced by Dow Corning Toray Co., Ltd.) as the thermosetting resin (epoxy resin); 7.0 wt % of the ethylene glycol dimethacrylate (“NK Ester A-200” produced by Shin-Nakamura Chemical Co., Ltd.) as the photo polymerizable resin; and 55.0 wt % of the spherical silica having the average particle size of 0.33 μm and the maximum particle size of 0.8 μm (“SFP-20M” produced by DENKI KAGAKU KOGYO KABUSHIKI KAISHA) as the inorganic filler were weighed, and methyl ethyl ketone (“MEK” produced by DAISHIN CHEMICAL CO., LTD.) was added thereto so that an amount (concentration) of the resin components contained in a resin varnish finally obtained is adjusted to 71 wt %.

Thereafter, the above components were stirred until the cresol novolac-type resin (EPICLON N-665) was dissolved thereinto.

Next, the silica was dispersed thereinto using the bead mill mixer (bead diameter: 400 μm, processing speed: 6 g/s, 5 passes).

Next, 1.0 wt % of the benzyl dimethyl ketal (“IRGACURE 651” produced by Ciba Specialty Chemicals) as the photo initiator was added thereinto, and they were stirred using the stirring blade (450 rpm) for 1 hour, to obtain a resin varnish.

In this regard, it is to be noted that in the obtained semiconductor wafer bonding product, the elastic modulus at 25° C. of the spacer was 9.9 GPa, the average linear expansion coefficient at 0 to 30° C. thereof was 49 ppm/° C. and the residual stress at 25° C. thereof was 9 MPa.

### Example 9

Bonded bodies and semiconductor wafer bonding products were manufactured in the same manner as Example 1, except that the preparation of the resin varnish (that is, the above step “2.”) was carried out as follows.

25.0 wt % of the solid content of the above methacryloyl-modified bisphenol A novolac resin (MPN001) as the alkali soluble resin; 16.0 wt % of the cresol novolac-type epoxy resin (“EPICLON N-665” produced by DIC Corporation) and 4.0 wt % of the siloxane-modified epoxy resin (“BY16-115” produced by Dow Corning Toray Co., Ltd.) as the thermosetting resin (epoxy resin); 8.0 wt % of the ethylene glycol dimethacrylate (“NK Ester A-200” produced by Shin-Nakamura Chemical Co., Ltd.) as the photo polymerizable resin; and 45.0 wt % of the spherical silica having the average particle size of 0.33 μm and the maximum particle size of 0.8 μm (“SFP-20M” produced by DENKI KAGAKU KOGYO KABUSHIKI KAISHA) as the inorganic filler were weighed, and the methyl ethyl ketone (“MEK” produced by DAISHIN CHEMICAL CO., LTD.) was added thereto so that an amount (concentration) of the resin components contained in a resin varnish finally obtained is adjusted to 71 wt %.

Thereafter, the above components were stirred until the cresol novolac-type resin (EPICLON N-665) was dissolved thereinto.

Next, the silica was dispersed thereinto using the bead mill mixer (bead diameter: 400 μm, processing speed: 6 g/s, 5 passes).

Next, 2.0 wt % of the benzyl dimethyl ketal (“IRGACURE 651” produced by Ciba Specialty Chemicals) as the photo initiator was added thereinto, and they were stirred using the stirring blade (450 rpm) for 1 hour, to obtain a resin varnish.

In this regard, it is to be noted that in the obtained semiconductor wafer bonding product, the elastic modulus at 25° C. of the spacer was 8.5 GPa, the average linear expansion coefficient at 0 to 30° C. thereof was 60 ppm/° C. and the residual stress at 25° C. thereof was 11 MPa.

### Comparative Example 1

Bonded bodies and semiconductor wafer bonding products were manufactured in the same manner as Example 1, except that the preparation of the resin varnish (that is, the above step “2.”) was carried out as follows.

35.0 wt % of the solid content of the above methacryloyl-modified bisphenol A novolac resin (MPN001) as the alkali soluble resin; and 63.0 wt % of the dipentaerythritol hexaacrylate (“LIGHT-ACRYLATE DPE-6A” produced by KYOEISHA CHEMICAL Co., LTD.) as the photo polymerizable resin were weighed, and the methyl ethyl ketone (“MEK” produced by DAISHIN CHEMICAL CO., LTD.) was added thereto so that an amount (concentration) of the resin components contained in a resin varnish finally obtained is adjusted to 71 wt %.

Next, 2.0 wt % of the benzyl dimethyl ketal (“IRGACURE 651” produced by Ciba Specialty Chemicals) as the photo initiator was added thereinto, and they were stirred using the stirring blade (450 rpm) for 1 hour, to obtain a resin varnish.

In this regard, it is to be noted that in the obtained semiconductor wafer bonding product, the elastic modulus at 25° C. of the spacer was 5.2 GPa, the average linear expansion coefficient at 0 to 30° C. thereof was 118 ppm/° C. and the residual stress at 25° C. thereof was 107 MPa.

### Comparative Example 2

Bonded bodies and semiconductor wafer bonding products were manufactured in the same manner as Example 1, except that the preparation of the resin varnish (that is, the above step “2.”) was carried out as follows.

45.0 wt % of the solid content of the above methacryloyl-modified bisphenol A novolac resin (MPN001) as the alkali soluble resin; and 53.0 wt % of the dipentaerythritol hexaacrylate (“LIGHT-ACRYLATE DPE-6A” produced by KYOEISHA CHEMICAL Co., LTD.) as the photo polymerizable resin were weighed, and the methyl ethyl ketone (“MEK” produced by DAISHIN CHEMICAL CO., LTD.) was added thereto so that an amount (concentration) of the resin components contained in a resin varnish finally obtained is adjusted to 71 wt %.

Next, 2.0 wt % of the benzyl dimethyl ketal (“IRGACURE 651” produced by Ciba Specialty Chemicals) as the photo initiator was added thereinto, and they were stirred using the stirring blade (450 rpm) for 1 hour, to obtain a resin varnish.

In this regard, it is to be noted that in the obtained semiconductor wafer bonding product, the elastic modulus at 25° C. of the spacer was 5.0 GPa, the average linear expansion coefficient at 0 to 30° C. thereof was 101 ppm/° C. and the residual stress at 25° C. thereof was 90 MPa.

In Table 1, indicated is the amount (wt %) of each component contained in the resin composition constituting the spacer formation layer obtained in each of Examples and Comparative Examples.

TABLE 1

| | | | Ex. | | | | | | | | | Com. Ex. | |
|---|---|---|---|---|---|---|---|---|---|---|---|---|---|
| | | | 1 | 2 | 3 | 4 | 5 | 6 | 7 | 8 | 9 | 1 | 2 |
| Alkali | Methacryloyl- | | 30.0 | 40.0 | 55.0 | 45.0 | 45.0 | 45.0 | 45.0 | 20.0 | 25.0 | 35.0 | 45.0 |
| soluble | modified | | | | | | | | | | | | |
| resin | bisphenol A | | | | | | | | | | | | |
| | novolac resin | | | | | | | | | | | | |
| Thermo- | Cresol | “EPICLON N-665” | 19.0 | 19.0 | 15.0 | 27.0 | 30.0 | 30.0 | 30.0 | 14.0 | 16.0 | | |
| setting | novolac-type | DIC Corporation | | | | | | | | | | | |
| resin | epoxy resin | | | | | | | | | | | | |
| | Siloxane- | “BY16-115” | 5.0 | 3.0 | 5.0 | 3.0 | 8.0 | 8.0 | 8.0 | 3.0 | 4.0 | | |
| | modified epoxy | Dow Cornng Toray | | | | | | | | | | | |
| | resin | Co., Ltd. | | | | | | | | | | | |
| Photo | Ethylene glycol | “NK Ester A-200” | 10.0 | 10.0 | | | | | 15.0 | 7.0 | 8.0 | | |
| polymerizable | dimethacrylate | Shin-Nakamura | | | | | | | | | | | |
| resin | | Chemical Co., Ltd. | | | | | | | | | | | |
| | Trimethylol | “NK Ester A-TMP” | | | 17.0 | | | | | | | | |
| | propane | Shin-Nakamura | | | | | | | | | | | |
| | trimethacrylate | Chemical Co., Ltd. | | | | | | | | | | | |
| | Tetramethylol | “NK Ester A-TMMT” | | | | 23.0 | 15.0 | | | | | | |
| | methane | Shin-Nakamura | | | | | | | | | | | |
| | tetraacrylate | Chemical Co., Ltd. | | | | | | | | | | | |
| | Dipenta- | “LIGHT-ACRYLATE | | | | | | 15.0 | | | | 63.0 | 53.0 |
| | erythritol | DPE-6A” | | | | | | | | | | | |
| | hexaacrylate | KYOEISHA | | | | | | | | | | | |
| | | CHEMICAL | | | | | | | | | | | |
| | | Co., LTD. | | | | | | | | | | | |
| Photo | Benzyl dimethyl | “IRGACURE 651” | 1.0 | 1.0 | 1.0 | 2.0 | 2.0 | 2.0 | 2.0 | 1.0 | 2.0 | 2.0 | 2.0 |
| initiator | ketal | Ciba Specialty | | | | | | | | | | | |
| | | Chemicals | | | | | | | | | | | |
| Dissolution | Phenol novolac | “PR-HF-6” | | 2.0 | 7.0 | | | | | | | | |
| accelerator | resin | Sumitomo Bakelite | | | | | | | | | | | |
| | | Co., Ltd. | | | | | | | | | | | |
| Filler | Silica | “SFP-20M” | 35.0 | 25.0 | | | | | | 55.0 | 45.0 | | |
| | | DENKI KAGAKU | | | | | | | | | | | |
| | | KOGYO | | | | | | | | | | | |
| | | KABUSHIKI | | | | | | | | | | | |
| | | KAISHA | | | | | | | | | | | |

| | | | | | | | | | | | |
|---|---|---|---|---|---|---|---|---|---|---|---|
| Total | 100.0 | 100.0 | 100.0 | 100.0 | 100.0 | 100.0 | 100.0 | 100.0 | 100.0 | 100.0 | 100.0 |

[2] Evaluation of Warp of Bonded Body

First, each of the bonded bodies obtained in Examples and Comparative Examples was heated under the conditions of 150° C. and 90 minutes. In this way, the spacer of each of the bonded bodies was thermally cured.

On each of the bonded bodies obtained in Examples and Comparative Examples after the spacer was thermally cured, a warpage thereof was measured using a surface roughness measuring apparatus (“surfcom 1400D-64” produced by TOKYO SEIMITSU CO., LTD.).

Next, on each of the bonded bodies obtained in Examples and Comparative Examples, a lower surface (back side) of the semiconductor wafer thereof was ground using a grinder (“DFG8540” produced by DISCO Corporation) so that a thickness of a central portion of the semiconductor wafer became 145 μm. Namely, the semiconductor wafer was ground so as to have one-fifth thickness.

Thereafter, the warpage of each of the bonded bodies after the grinding (back grinding) was measured in the same manner as described above.

In the following Table 2, indicated is the warpage of each of the bonded bodies obtained in Examples and Comparative Examples before and after the back grinding thereof, respectively.

In this regard, it is to be noted that the warpage is an average value of values measured in 5 bonded bodies obtained in each of Examples and Comparative Examples.

[3] Evaluation of Influence on Bonded Body by Back Grinding

In Examples and Comparative Examples, after each of the bonded bodies passed through the above step “5.” was back ground in the above step “6.”, influence on the bonded body by the back grinding was evaluated as follows.

Namely, after each of the bonded bodies obtained in Examples and Comparative Examples was back ground, thicknesses of the semiconductor wafer thereof was measured at arbitrary 10 points, and then the influence on the bonded body by the back grinding was evaluated based on the following evaluation criteria.

A: Variation in the thicknesses of the semiconductor wafer after the grinding (that is, a difference between a maximum value and a minimum value thereof) is less than 10 μm.

B: Variation in the thicknesses of the semiconductor wafer after the grinding is in the range of 10 to 30 μm within which a problem would not practically occur.

C: Variation in the thicknesses of the semiconductor wafer after the grinding is 30 μm or more.

[4] Ease of Dicing of Semiconductor Wafer Bonding Product

In Examples and Comparative Examples, after each of the semiconductor wafer bonding products passed through the above steps “5.” and “6.” was diced in the above step “7.”, ease of dicing of the semiconductor wafer bonding products was evaluated as follows.

A: A yield of dicing the semiconductor wafer bonding products is 95% or more.

B: A yield of dicing the semiconductor wafer bonding products is in the range of 90% or more but less than 95%.

C: The semiconductor wafer bonding products could not be transferred using a suction tool due to the warp thereof.

The evaluation results of the evaluations [2] to [4] carried out in the above ways are indicated in Table 2.

Further, on each of the bonded bodies obtained in Examples and Comparative Examples, according to the warpage thereof indicated in Table 2, an increasing ratio of the warpage of the bonded body after the back grinding thereof with respect to the warpage of the bonded body before the back grinding thereof was calculated.

This result is also indicated in the following Table 2.

TABLE 2

| | Ex. | | | | | | | | | Com. Ex. | |
|---|---|---|---|---|---|---|---|---|---|---|---|
| | 1 | 2 | 3 | 4 | 5 | 6 | 7 | 8 | 9 | 1 | 2 |
| Warpage before process | 130 | 170 | 180 | 410 | 340 | 330 | 240 | 45 | 60 | 610 | 470 |
| [μm] | | | | | | | | | | | |
| Warpage after process | 330 | 380 | 520 | 1210 | 840 | 890 | 640 | 280 | 310 | — | 3380 |
| [μm] | | | | | | | | | | | |
| Increasing ratio of | 154 | 124 | 189 | 195 | 147 | 170 | 167 | 522 | 417 | — | 619 |
| warpage after process [%] | | | | | | | | | | | |
| Elastic modulus at 25° C. | 7.8 | 3.0 | 2.4 | 5.1 | 4.5 | 3.8 | 1.4 | 9.9 | 8.5 | 5.2 | 5.0 |
| [GPa] | | | | | | | | | | | |
| Average linear expansion | 68 | 70 | 84 | 95 | 91 | 89 | 93 | 49 | 60 | 118 | 101 |
| coefficient (0 to 30° C.) | | | | | | | | | | | |
| Residual stress [MPa] | 16 | 16 | 18 | 63 | 32 | 43 | 23 | 9 | 11 | 107 | 90 |
| Influence by back grinding | A | A | A | B | A | A | A | A | A | C | B |
| Dicing property | A | A | A | B | B | B | A | A | A | — | C |

As shown in Table 2, obtained is a result that the warpage of each of the bonded bodies obtained in Examples after the grinding thereof is suppressed to 3,000 μm or less. Further, obtained is a result that the warpage of each of the bonded bodies obtained in Examples before the grinding thereof is suppressed to 500 μm or less and the increasing ratio of the warpage of each of the bonded bodies after the back grinding thereof is suppressed to 600% or less.

On the other hand, the warpage of each of the bonded bodies obtained in Comparative Example 1 before the back grinding thereof exceeded 500 μm, and thus each boded body could not be set to a back grinding machine.

Further, the warpage of each of the bonded bodies obtained in Comparative Example 2 exceeded 3,000 μm and the increasing ratio of the warpage of each boded body after the back grinding thereof exceeded 600%, and thus each boded body could not be transferred using the suction tool of the dicing machine.

For these results, it appears that by forming the spacer using the resin composition constituted from the material containing the alkali soluble resin, the thermosetting resin and the photo initiator, the warpage of the bonded body after the grinding thereof is suppressed to 3,000 μm or less. Further, by doing so, it also appears that the warpage of the bonded body before the grinding thereof is suppressed to 500 μm or less and the increasing ratio of the warpage of the bonded body after the back grinding thereof is suppressed to 600% or less.

Further, by suppressing the warpage of the bonded body after the grinding thereof to 3,000 μm or less, or by suppressing the warpage of the bonded body before the grinding thereof to 500 μm or less and the increasing ratio of the warpage of the bonded body after the back grinding thereof to 6000 or less, it is be understood that the semiconductor wafer bonding product can be diced in a high yield.

### INDUSTRIAL APPLICABILITY

According to the present invention, in the case where a semiconductor wafer having a substantially circular shape, a diameter of 8 inches and a thickness of 725 μm and a transparent substrate having a substantially circular shape, a diameter of 8 inches and a thickness of 350 μm are bonded together through a spacer formed on a substantially overall surface of the semiconductor wafer or the transparent substrate to thereby obtain a bonded body, a surface of the semiconductor wafer opposite to the spacer is subjected to a process for substantially uniformly grinding and/or polishing it so that the semiconductor wafer has one-fifth thickness, a warpage of the bonded body is suppressed to 3,000 μm or less.

Therefore, it is possible to effectively suppress or prevent a semiconductor wafer bonding product from being not set to a machine for carrying out a back side processing step or a dicing step or from being broken by being hooked into the machine.

Further, according to the present invention, the warpage of the bonded body before the process thereof is suppressed to 500 μm or less, and an increasing ratio of the warpage of the bonded body after the process thereof is suppressed to 600% or less. Therefore, it is possible to prevent the semiconductor wafer bonding product from being not received into a magazine case to be used for setting it to the above machine in the back side processing step or the dicing step setting. Further, it is also possible to prevent the semiconductor wafer bonding product from being not sucked inside the machine, to thereby smoothly proceed with the process thereof. Such a present invention provides industrial applicability.

What is claimed is:

1. A resin composition adapted to be used for providing a spacer having a grid-like shape at a planar view thereof between a semiconductor wafer and a transparent substrate, the resin composition comprising:
a constituent material containing an alkali soluble resin, a thermosetting resin and a photo initiator,
wherein in the case where a semiconductor wafer having a substantially circular shape, a diameter of 8 inches and a thickness of 725 μm and a transparent substrate having a substantially circular shape, a diameter of 8 inches and a thickness of 350 μm are bonded together through a spacer formed on a substantially overall surface of the semiconductor wafer or the transparent substrate using the resin composition to thereby obtain a bonded body, a surface of the semiconductor wafer opposite to the spacer is subjected to a process for substantially uniformly grinding and/or polishing it so that the semiconductor wafer has one-fifth thickness, and then the bonded body is placed on a flat surface so that the transparent substrate is located on the downside facing to the flat surface, a maximal height of a space to be defined between the flat surface and the transparent substrate, which corresponds to a warpage of the bonded body, is 3,000 μm or less.

2. The resin composition as claimed in claim 1, wherein the warpage of the bonded body before the grinding and/or polishing process is 500 μm or less, and an increasing ratio of the warpage of the bonded body after the process thereof is 600% or less.

3. The resin composition as claimed in claim 1, wherein the alkali soluble resin contains one or more selected from the group consisting of an (epoxy)acrylate containing carboxyl groups, an acryl resin containing carboxyl groups, an epoxy resin containing carboxyl groups, a (meth)acryl-modified phenol resin and a polyamic acid.

4. The resin composition as claimed in claim 1, wherein the alkali soluble resin is a (meth)acryl-modified phenol resin.

5. The resin composition as claimed in claim 1, wherein the thermosetting resin is an epoxy resin.

6. The resin composition as claimed in claim 1, wherein the constituent material further contains a photo polymerizable resin.

7. The resin composition as claimed in claim 1, wherein the spacer is obtained by photo curing and thermal curing a layer formed of the resin composition.

8. The resin composition as claimed in claim 1, wherein an elastic modulus at 25° C. of the spacer is in the range of 0.1 to 15 GPa.

9. The resin composition as claimed in claim 1, wherein a linear expansion coefficient at 0 to 30° C. of the spacer is in the range of 3 to 150 ppm/° C.

10. The resin composition as claimed in claim 1, wherein a residual stress at 25° C. of the spacer is in the range of 0.1 to 150 MPa.

11. The resin composition as claimed in claim 1, wherein a thickness of the spacer is in the range of 5 to 500 μm.

12. A semiconductor wafer bonding product having a substantially circular shape, in which a semiconductor wafer, a spacer formed of the resin composition defined by claim 1 so as to have a plurality of air-gap portions provided in a grid pattern and a transparent substrate are laminated in this order.

13. A semiconductor device obtained by dicing the semiconductor wafer bonding product defined by claim 12.
